(19) United States
(12) Patent Application Publication
(10) Pub. No.: US 2007/0257600 A1
(43) Pub. Date: Nov. 8, 2007

(54) Organic Electroluminescent Device

(75) Inventors: Masahide Matsuura, Chiba (JP); Toshihiro Iwakuma, Chiba (JP); Keiko Yamamichi, Chiba (JP); Chishio Hosokawa, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Idemitsu Kosan Co., Ltd., Chiyoda-ku (JP)

(21) Appl. No.: 10/588,549

(22) PCT Filed: Feb. 8, 2005
(86) PCT No.: PCT/JP05/01799

§ 371 Date: Apr. 13, 2007

(30) Foreign Application Priority Data
Feb. 9, 2004 (JP) 2004-032542

(51) Int. Cl. H01J 1/62

(52) U.S. Cl. 313/498

(57) ABSTRACT

Organic electroluminescent device (100) having a multilayer structure including at least emitting layer (15) and electron-transporting layer (16) between cathodes (17) and (18) and anode (12), the triplet energy gap (Eg^{T}) of a host material forming emitting layer (15) being 2.52 eV or more and 3.7 eV or less, an electron-transporting material forming electron-transporting layer (16) being different from the host material, and having hole-transporting properties, and emitting layer (15) including a phosphorescent metal complex compound containing a heavy metal.

### TECHNICAL FIELD

The invention relates to an organic electroluminescent device (hereinafter abbreviated as “organic EL device”). More particularly, the invention relates to a highly efficient organic EL device.

### BACKGROUND ART

An organic EL device using an organic substance is a promising solid-state emitting type inexpensive and large full-color display device, and has been extensively developed. An EL device generally includes an emitting layer and a pair of opposing electrodes holding the emitting layer therebetween.

In the EL device, electrons and holes are injected into the emitting layer respectively from a cathode and an anode upon application of an electric field between the electrodes. The electrons and the holes recombine in the emitting layer to produce an excited state, and the energy is emitted as light when the excited state returns to the ground state. The EL device emits light by utilizing this phenomenon.

Various configurations have been known as the configuration of the organic EL device. For example, use of an aromatic tertiary amine as a material for a hole-transporting layer has been disclosed for an organic EL device having the device configuration of “indium tin oxide (ITO)/hole-transporting layer/emitting layer/cathode” (see JP-A-63-295695). This device configuration achieves a high luminance of several hundreds cd/m² at an applied voltage of 20 V or less.

It has been reported that an emission efficiency of about 40 lm/W or more is achieved at a luminance equal to or less than several hundreds cd/m² by using an iridium complex (phosphorescent dopant) as a dopant for an emitting layer (see Tsutsui et al., “Japanese Journal of Physics”, Vol. 38 (1999), p. 1502-1504).

However, since most phosphorescent organic EL devices emit green light, a phosphorescent organic EL device which emits blue light has been demanded. Moreover, an increase in the efficiency of the phosphorescent organic EL device has also been demanded.

When applying the organic EL device to a flat panel display or the like, the organic EL device is required to exhibit improved emission efficiency and reduced power consumption. However, the above-mentioned device configuration has a disadvantage in that the emission efficiency significantly decreases accompanying an increase in luminance. Therefore, it is difficult to reduce the power consumption of the flat panel display.

On the other hand, technologies relating to a hole barrier layer, which is one of the layers of the organic EL device, have been disclosed (see U.S. Pat. No. 6,097,147 and JP-A-2002-203683). These technologies improve current efficiency by using an organic compound having a high ionization potential as a material for the hole barrier layer. However, the drive voltage of the organic EL device is disadvantageously increased due to accumulated holes.

The invention was achieved in view of the above-described situation. An object of the invention is to provide a phosphorescent organic EL device which is driven at a low voltage and exhibits high current efficiency.

### DISCLOSURE OF THE INVENTION

According to the invention, the following organic EL device is provided.

1. An organic EL device having a multilayer structure comprising at least an emitting layer and an electron-transporting layer between a cathode and an anode, the triplet energy gap (Eg^{T}) of a host material forming the emitting layer being 2.52 eV or more and 3.7 eV or less, an electron-transporting material forming the electron-transporting layer being different from the host material, and having hole-transporting properties, and the emitting layer comprising a phosphorescent metal complex compound containing a heavy metal.

2. The organic EL device according to 1, wherein the ionization potential (Ip) of the electron-transporting material forming the electron-transporting layer is 5.6 eV or more and less than 6.0 eV.

3. The organic EL device according to 1 or 2, wherein the electron-transporting material forming the electron-transporting layer is at least an electron-deficient nitrogen-containing five-membered ring derivative or a nitrogen-containing six-membered ring derivative.

4. The organic EL device according to any of 1 to 3, wherein the electron-transporting material has one or more of the following structures (1) to (3). 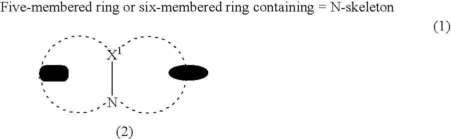
wherein X¹ is a carbon atom or a nitrogen atom, and Z¹ and Z² are independently atom groups which can form a nitrogen-containing hetero ring

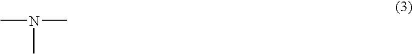

5. The organic EL device according to any of 1 to 4, wherein the electron-transporting material has a nitrogen-containing aromatic polycyclic group containing a five-membered ring or six-membered ring, and when the group contains a plurality of nitrogen atoms, the organic compound has a skeleton containing the nitrogen atoms in non-adjacent bonding positions.

6. The organic EL device according to any of 1 to 5, wherein the electron-transporting material or the host material is a compound having one carbazolyl group or tetrahydrocarbazolyl group.

7. The organic EL device according to any of 1 to 5, wherein the electron-transporting material or the host material is a compound having two carbazolyl groups or tetrahydrocarbazolyl groups.

8. The organic EL device according to any of 1 to 5, wherein the electron-transporting material or the host material is a compound having a carbazolyl group or a tetrahydrocarbazolyl group, and a nitrogen-containing hetero ring group.

9. The organic EL device according to any of 1 to 8, wherein a difference (ΔIp=Ip (electron-transporting material)−Ip (host material)) in ionization potential between the host material forming the emitting layer and the electron-transporting material forming the electron-transporting layer which contacts the emitting layer is −0.2 eV<ΔIp<0.4 eV.

10. The organic EL device according to any of 1 to 9, having a plurality of electron-transporting layers.

11. The organic EL device according to 10, wherein a difference (ΔIp′), represented by the following expression, in ionization potential between electron-transporting materials forming two adjacent layers of the plurality of electron-transporting layers is −0.2 eV<ΔIp′<0.4 eV,
ΔIp′=Ip(i)−Ip(i+1)
wherein Ip (i) is the ionization potential of an electron-transporting material forming an i-th electron-transporting layer from the emitting layer (i is an integer of 1 or more and (N-1) or less, and N is the number of the electron-transporting layers).

12. The organic EL device according to 10 or 11, wherein the optical energy gap (Eg) of an electron-transporting material forming an electron-transporting layer is equal to or smaller than the optical energy gap (Eg) of an electron-transporting material forming the adjacent electron-transporting layer nearer to the emitting layer.

13. The organic EL device according to any of 10 to 12, wherein the triplet energy gap of an electron-transporting material forming an electron-transporting layer is equal to or smaller than the triplet energy gap of an electron-transporting material forming the adjacent electron-transporting layer nearer to the emitting layer.

14. The organic EL device according to any of 1 to 13, wherein the triplet energy gap of the electron-transporting material forming the electron-transporting layer contacting the emitting layer is larger than the triplet energy gap of the metal complex compound of the emitting layer.

In the organic EL device according to the invention, the host material forming the emitting layer is the major material for the emitting layer, and the phosphorescent metal complex compound containing a heavy metal functions as a luminescent dopant.

The electron-transporting layer is positioned on the side of the cathode between the cathode and the anode.

In the invention, the organic EL device according to 1 includes at least one electron-transporting layer. It is preferable that the expression relating to ΔIp be satisfied when the number of electron-transporting layers is one. When the number of electron-transporting layers is plural, it is preferable that at least the expression relating to ΔIp be satisfied. It is more preferable that at least two adjacent electron-transporting layers satisfy the expression relating to ΔIp′. It is still more preferable that all the adjacent electron-transporting layers satisfy the expression relating to ΔIp′. This also applies to the case where the number of emitting layers is plural.

The invention provides, a phosphorescent organic EL device, particularly emitting light in a blue region, which is driven at a low voltage and exhibits high current efficiency.

### BRIEF DESCRIPTION OF THE DRAWINGS

FIG. 1 is a view showing organic EL devices according to Examples 1 to 6.

### BEST MODE FOR CARRYING OUT THE INVENTION

An organic EL device according to the invention has a multilayer structure including at least an emitting layer and an electron-transporting layer between a cathode and an anode. The emitting layer and the electron-transporting layer may respectively have a single-layer configuration or a multilayer configuration.

In the organic EL device according to the invention, a host material forming the emitting layer has a triplet energy gap (Eg^{T}) of 2.52 eV or more and 3.7 eV or less, preferably 2.75 eV or more and 3.7 eV or less, still more preferably 2.80 eV or more and 3.7 eV or less, particularly preferably 2.9 eV or more and 3.7 eV or less, and even more preferably 3.3 eV or more and 3.7 eV or less. A host material having a triplet energy gap within the above range allows a luminescent dopant (described later) of an arbitrary color (blue to red) which may be used in the invention to efficiently emit light.

In the organic EL device according to the invention, an electron-transporting material forming the electron-transporting layer differs from the host material and has hole-transporting properties.

This facilitates the hole mobility in the electron-transporting layer, whereby hole accumulation due to the difference in ionization potential between the emitting layer and the electron-transporting layer can be prevented. As a result, an increase in drive voltage can be suppressed.

The statement “the electron-transporting material has hole-transporting properties” means that hole mobility can be measured for the electron-transporting material.

The hole mobility may be measured by an arbitrary method. For example, a time of flight method (method which calculates hole mobility from measured charge transit time in an organic film) may be used. In the time of flight method, light having a wavelength absorbed by an organic layer is irradiated to a structure including “electrode/organic layer (layer formed of organic material forming electron-transporting layer)/electrode” to measure the transient current time properties (transit time), and the hole mobility is calculated using the following expression. Note that electron mobility can also be measured by this method.
Mobility=(thickness of organic film)²/(transit time·applied voltage)
Field intensity=(voltage applied to device)/(thickness of organic layer)

In the invention, it is preferable that the electron-transporting material have a hole mobility (μ(h)) measured by the time of flight method of 1.0×10⁻⁷ cm²/(V·s)<μ(h) at a field intensity of 10⁵ to 10⁷ V/cm. It is particularly preferable that it has a hole mobility of more than 1.0×10⁻⁵ cm²/(V·s).

In the organic EL device according to the invention, the emitting layer includes a phosphorescent metal complex compound (luminescent dopant) containing a heavy metal.

The invention is characterized in that the luminescent dopant emits light in the organic EL device due to the triplet energy gap.

This allows the hole-electron recombination energy in the organic EL device to be more efficiently transferred to the luminescent dopant to contribute to emission of light.

The ionization potential of the electron-transporting material forming the electron-transporting layer is preferably 5.6 eV or more and less than 6.0 eV.

The difference between the ionization potential of the host material forming the emitting layer and the ionization potential of the electron-transporting material forming the electron-transporting layer which contacts the emitting layer (ΔIp=Ip(electron-transporting material)−Ip(host material)) is preferably −0.2 eV<ΔIp<0.4 eV, more preferably −0.2 eV<ΔIp<0.2 eV.

If the difference ΔIp is in this range, hole accumulation due to the difference in ionization potential between the emitting layer and the electron transporting layer can be prevented. As a result, an increase in drive voltage can be suppressed.

When the organic EL device according to the invention includes a plurality of (N) electron transporting layers, the difference (ΔIp′) in ionization potential between the electron-transporting materials forming two adjacent layers of the electron-transporting layers represented by the following expression is preferably −0.2 eV<ΔIp′<0.4 eV, and still more preferably −0.2 eV<ΔIp′<0.2 eV.
ΔIp′=Ip(i)−Ip(i+1)
Ip (i): ionization potential of electron-transporting material forming i-th (i is an integer of 1 or more and (N-1) or less) electron-transporting layer from the side of the emitting layer

If ΔIp′ is in this range, since a hole barrier which may cause hole accumulation is reduced, the drive voltage can be reduced, whereby a high luminous efficiency can be obtained.

When the organic EL device according to the invention includes a plurality of electron transporting layers, the optical energy gap (Eg) of the electron-transporting material forming each electron-transporting layer is preferably equal to or smaller than the optical energy gap (Eg) of the electron-transporting material forming the adjacent electron-transporting layer nearer to the emitting layer. That is, it is preferable that N electron transporting layers satisfy the following relationship.
Eg(N)≦Eg(N-1)≦ . . . ≦Eg(2)≦Eg(1) (i)
Eg (x): optical energy gap of x-th (x is an integer of 1 or more and N or less) electron transporting layer from the side of the emitting layer

When the organic EL device according to the invention includes a plurality of electron transporting layers, the triplet energy gap (Eg^{T}) of the electron-transporting material forming each electron-transporting layer is preferably equal to or smaller than the triplet energy gap (Eg^{T}) of the electron-transporting material forming the adjacent electron-transporting layer nearer to the emitting layer.

That is, it is preferable that N electron transporting layers satisfy the following relationship.
Eg^{T}(N)≦Eg^{T}(N-1)≦ . . . ≦Eg^{T}(2)≦Eg^{T}(1) (ii)
Eg^{T} (x): triplet energy gap of x-th (x is an integer of 1 or more and N or less) electron transporting layer from the side of the emitting layer

The organic EL device according to the invention preferably satisfies the following expression when the triplet energy gap of the luminescent dopant of the emitting layer is indicated by Eg^{T} (dopant).
Eg^{T}(1)>Eg^{T}(dopant) (iii)
Eg^{T} (1): triplet energy gap of electron transporting layer which contacts the emitting layer

The recombination energy in the emitting layer can be prevented from diffusing into the electron transporting layer by satisfying the above expressions (i) to (iii), whereby the energy of the host material is efficiently transferred to the luminescent dopant. As a result, a high current efficiency can be realized.

The host material, the luminescent dopant, and the electron transporting material used for the organic EL device according to the invention are not particularly limited insofar as the above-described conditions are satisfied.

As preferable examples of the host material, compounds exhibiting excellent thin film formability, such as amine derivatives, carbazole derivatives, oxadiazole derivatives, triazole derivatives, benzoxazole type, benzothiazole type, and benzimidazole type fluorescent whitening agents, metal chelate oxanoid compounds, and styryl compounds, can be given. In the invention, an electron transporting material described later may be used as the host material.

It is preferable that the luminescent dopant function as a luminescent dopant which emits light from the triplet state at room temperature. As preferable examples of the heavy metal contained in the dopant, Ir, Pt, Pd, Ru, Rh, Mo, and Re can be given. As examples of the ligand to the heavy metal, a ligand which is coordinated or bonded to a metal at C or N (CN ligand) and the like can be given. As specific examples of the ligand, the following compounds and substituted derivatives thereof can be given.

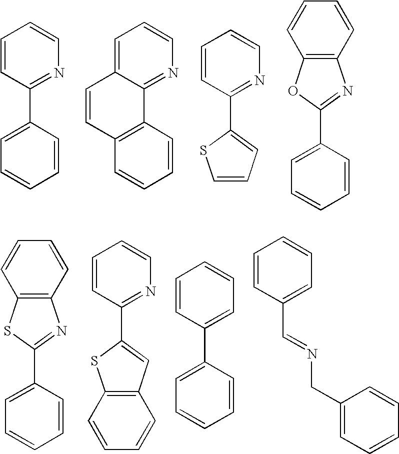

As examples of the substituent of the substituted derivatives, an alkyl group, alkoxy group, phenyl group, polyphenyl group, naphthyl group, fluoro (F) group, trifluoromethyl (CF₃) group, and the like can be given.

As preferable examples of a blue light emitting ligand, the following compounds and the like can be given.

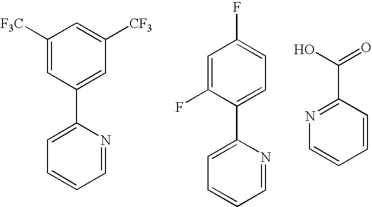

The material used for the electron-transporting layer is preferably at least an electron-deficient nitrogen-containing five-membered ring derivative or nitrogen-containing six-membered ring derivative. The term “electron-deficient” means that at least one carbon atom of a 6π aromatic ring is replaced with a nitrogen atom.

The electron-transporting material is preferably a compound having one or more of the following structures (1) to (3). 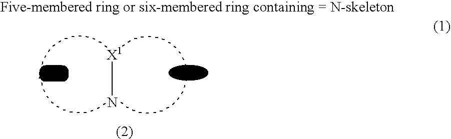
wherein X¹ is a carbon atom or a nitrogen atom, and Z¹ and Z² are independently atom groups which can form a nitrogen-containing hetero ring.

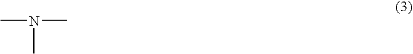

The electron-transporting material is still more preferably an organic compound in which one or more of the structures (1) to (3) form a nitrogen-containing aromatic polycyclic group containing a five-, six-, seven-, or eight-membered ring, and preferably a five- or six-membered ring, provided that, when the group contains a plurality of nitrogen atoms, the organic compound has a skeleton containing the nitrogen atoms in non-adjacent bonding positions.

As such a compound, a compound having a carbazolyl group, pyridyl group, pyrimidinyl group, pyrazinyl group, triazinyl group, quinoxalyl group, quinolyl group, imidazolyl group, triazolyl group, tetrazolyl group, oxadiazolyl group, thiadiazolyl group, or oxatriazolyl group (each group may have a substituent) is preferable.

As specific examples of such a compound, compounds having a structure shown by the following formula (4) can be given. 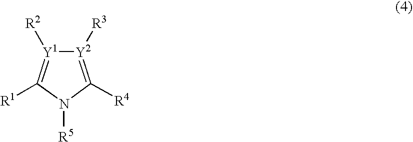
wherein R¹ to R⁵ represent group bonding positions, provided that R¹ and R², R³ and R⁴, and R² and R³ may form a ring, and Y¹ and Y² individually represent a carbon atom or a nitrogen atom (excluding the case where both of Y¹ and Y² represent nitrogen atoms), provided that R² or R³ does not exist when Y¹ or Y² represents a nitrogen atom.

It is also preferable that the electron-transporting material be a compound in which at least one of R¹, R⁴, and R⁵ in the formula (4) is a nitrogen atom or an aromatic ring, and the skeleton shown by the formula (4) is bonded to at least one skeleton shown by the formula (4) through at least one nitrogen atom or aromatic ring; or a compound in which at least one of R¹, R⁴, and R⁵ in the formula (4) is a nitrogen atom or an aromatic ring and the skeleton shown by the formula (4) is bonded to at least one skeleton shown by the formula (4) through at least one nitrogen atom or aromatic ring, and an alicyclic compound.

Specific examples of the compound having the structure shown by the formula (4) are given below.

In the invention, the skeleton groups shown by the following formulas are called a tetrahydrocarbazolyl group. 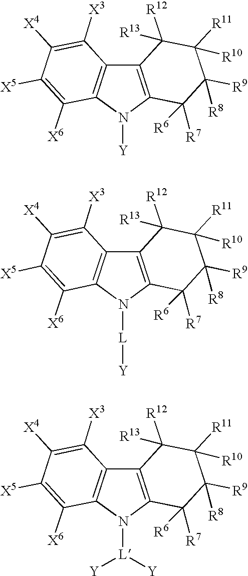
wherein Y represents a substituted or unsubstituted aryl group having 6 to 40 carbon atoms, substituted or unsubstituted heterocyclic group having 3 to 40 carbon atoms, substituted or unsubstituted linear or branched alkyl group having 1 to 30 carbon atoms, or substituted or unsubstituted cycloalkyl group having 5 to 40 carbon atoms.

L represents a substituted or unsubstituted arylene group having 6 to 40 carbon atoms, substituted or unsubstituted divalent heterocyclic group having 3 to 40 carbon atoms, substituted or unsubstituted linear or branched alkylene group having 1 to 30 carbon atoms, or substituted or unsubstituted cycloalkylene group having 5 to 40 carbon atoms.

L′ represents a substituted or unsubstituted trivalent aryl group having 6 to 40 carbon atoms, substituted or unsubstituted trivalent heterocyclic group having 3 to 40 carbon atoms, substituted or unsubstituted linear or branched trivalent alkyl group having 1 to 30 carbon atoms, or substituted or unsubstituted trivalent cycloalkyl group having 5 to 40 carbon atoms.

X³ to X⁶ individually represent a hydrogen atom, Y—, Y-L-, or Y-L′(-Y)— (Y, L, and L′ are the same as defined above).

R⁶ to R¹³ individually represent a hydrogen atom, halogen atom, cyano group, silyl group, substituted or unsubstituted amino group, substituted or unsubstituted aryl group having 6 to 40 carbon atoms, substituted or unsubstituted aryloxy group having 6 to 40 carbon atoms, substituted or unsubstituted heterocyclic group having 3 to 40 carbon atoms, substituted or unsubstituted linear or branched alkyl group having 1 to 30 carbon atoms, substituted or unsubstituted alkoxy group having 1 to 30 carbon atoms, substituted or unsubstituted aralkyl group having 7 to 40 carbon atoms, or substituted or unsubstituted cycloalkyl group having 5 to 40 carbon atoms.

Examples of the substituted or unsubstituted aryl group of Y include phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, O-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, fluorenyl, perfluoroaryl, 1,1′;3′,1″-terphenyl-5′-yl, 1,1′;3′,1″-terphenyl-2′-yl, and 1,1′;3′,1″-terphenyl-4′-yl.

Examples of the substituted or unsubstituted heterocyclic group of Y include pyrrole, pyridine, pyrimidine, pyrazine, triazine, aziridine, azaindolizine, indolizine, imidazol, indole, isoindole, indazole, purine, pteridine, and β-carboline.

Examples of the substituted or unsubstituted alkyl group of Y include methyl, trifluoromethyl, ethyl, propyl, isopropyl, n-butyl, s-butyl, isobutyl, t-butyl, n-pentyl, n-hexyl, n-heptyl, n-octyl, hydroxymethyl, 1-hydroxyethyl, 2-hydroxyethyl, 2-hydroxyisobutyl, 1,2-dihydroxyethyl, 1,3-dihydroxyisopropyl, 2,3-dihydroxy-t-butyl, 1,2,3-trihydroxypropyl, chloromethyl, 1-chloroethyl, 2-chloroethyl, 2-chloroisobutyl, 1,2-dichloroethyl, 1,3-dichloroisopropyl, 2,3-dichloro-t-butyl, 1,2,3-trichloropropyl, bromomethyl, 1-bromoethyl, 2-bromoethyl, 2-bromoisobutyl, 1,2-dibromoethyl, 1,3-dibromoisopropyl, 2,3-dibromo-t-butyl, 1,2,3-tribromopropyl, iodomethyl, 1-iodoethyl, 2-iodoethyl, 2-iodoisobutyl, 1,2-diiodoethyl, 1,3-diiodoisopropyl, 2,3-diiodo-t-butyl, 1,2,3-triiodopropyl, aminomethyl, 1-aminoethyl, 2-aminoethyl, 2-aminoisobutyl, 1,2-diaminoethyl, 1,3-diaminoisopropyl, 2,3-diamino-t-butyl, 1,2,3-triaminopropyl, cyanomethyl, 1-cyanoethyl, 2-cyanoethyl, 2-cyanoisobutyl, 1,2-dicyanoethyl, 1,3-dicyanoisopropyl, 2,3-dicyano-t-butyl, 1,2,3-tricyanopropyl, nitromethyl, 1-nitroethyl, 2-nitroethyl, 2-nitroisobutyl, 1,2-dinitroethyl, 1,3-dinitroisopropyl, 2,3-dinitro-t-butyl, and 1,2,3-trinitropropyl groups.

Examples of the substituted or unsubstituted cycloalkyl group of Y include cyclopentyl, cyclohexyl, 4-methylcyclohexyl, adamantyl, and norbornyl.

Examples of the substituted or unsubstituted arylene group of L include bivalent groups of the above examples of the substituted or unsubstituted aryl group.

Examples of the bivalent substituted or unsubstituted heterocyclic group with 3 to 40 carbon atoms of L include bivalent or more groups of the above examples of the substituted or unsubstituted heterocyclic group.

Examples of the substituted or unsubstituted alkylene group of L include bivalent groups of the above examples of the substituted or unsubstituted alkyl group.

Examples of the substituted or unsubstituted cycloalkylene group of L include bivalent groups of the above examples of the substituted or unsubstituted cycloalkyl group.

Examples of L′ include trivalent groups of the above examples of Y.

Examples of the halogen atom of R⁶ to R³¹ include fluorine, chlorine, bromine, and iodine.

Examples of the substituted or unsubstituted aryl group of R⁶ to R¹³ are the same as the above examples for Y.

The substituted or unsubstituted aryloxy groups of R⁶ to R¹³ are represented by —OP. Examples of P include phenyl, 1-naphthyl, 2-naphthyl, 1-anthryl, 2-anthryl, 9-anthryl, 1-phenanthryl, 2-phenanthryl, 3-phenanthryl, 4-phenanthryl, 9-phenanthryl, 1-naphthacenyl, 2-naphthacenyl, 9-naphthacenyl, 1-pyrenyl, 2-pyrenyl, 4-pyrenyl, 2-biphenylyl, 3-biphenylyl, 4-biphenylyl, p-terphenyl-4-yl, p-terphenyl-3-yl, p-terphenyl-2-yl, m-terphenyl-4-yl, m-terphenyl-3-yl, m-terphenyl-2-yl, o-tolyl, m-tolyl, p-tolyl, p-t-butylphenyl, p-(2-phenylpropyl)phenyl, 3-methyl-2-naphthyl, 4-methyl-1-naphthyl, 4-methyl-1-anthryl, 4′-methylbiphenylyl, 4″-t-butyl-p-terphenyl-4-yl, 2-pyrrolyl, 3-pyrrolyl, pyrazinyl, 2-pyridinyl, 3-pyridinyl, 4-pyridinyl, 2-indolyl, 3-indolyl, 4-indolyl, 5-indolyl, 6-indolyl, 7-indolyl, 1-isoindolyl, 3-isoindolyl, 4-isoindolyl, 5-isoindolyl, 6-isoindolyl, 7-isoindolyl, 2-furyl, 3-furyl, 2-benzofuranyl, 3-benzofuranyl, 4-benzofuranyl, 5-benzofuranyl, 6-benzofuranyl, 7-benzofuranyl, 1-isobenzofuranyl, 3-isobenzofuranyl, 4-isobenzofuranyl, 5-isobenzofuranyl, 6-isobenzofuranyl, 7-isobenzofuranyl, 2-quinolyl, 3-quinolyl, 4-quinolyl, 5-quinolyl, 6-quinolyl, 7-quinolyl, 8-quinolyl, 1-isoquinolyl, 3-isoquinolyl, 4-isoquinolyl, 5-isoquinolyl, 6-isoquinolyl, 7-isoquinolyl, 8-isoquinolyl, 2-quinoxalinyl, 5-quinoxalinyl, 6-quinoxalinyl, 1-carbazolyl, 2-carbazolyl, 3-carbazolyl, 4-carbazolyl, 1-phenanthrydinyl, 2-phenanthrydinyl, 3-phenanthrydinyl, 4-phenanthrydinyl, 6-phenanthrydinyl, 7-phenanthrydinyl, 8-phenanthrydinyl, 9-phenanthrydinyl, 10-phenanthrydinyl, 1-acrydinyl, 2-acrydinyl, 3-acrydinyl, 4-acrydinyl, 9-acrydinyl, 1,7-phenanthroline-2-yl, 1,7-phenanthroline-3-yl, 1,7-phenanthroline-4-yl, 1,7-phenanthroline-5-yl, 1,7-phenanthroline-6-yl, 1,7-phenanthroline-8-yl, 1,7-phenanthroline-9-yl, 1,7-phenanthroline-10-yl, 1,8-phenanthroline-2-yl, 1,8-phenanthroline-3-yl, 1,8-phenanthroline-4-yl, 1,8-phenanthroline-5-yl, 1,8-phenanthroline-6-yl, 1,8-phenanthroline-7-yl, 1,8-phenanthroline-9-yl, 1,8-phenanthroline-10-yl, 1,9-phenanthroline-2-yl, 1,9-phenanthroline-3-yl, 1,9-phenanthroline-4-yl, 1,9-phenanthroline-5-yl, 1,9-phenanthroline-6-yl, 1,9-phenanthroline-7-yl, 1,9-phenanthroline-8-yl, 1,9-phenanthroline-10-yl, 1,10-phenanthroline-2-yl, 1,10-phenanthroline-3-yl, 1,10-phenanthroline-4-yl, 1,10-phenanthroline-5-yl, 2,9-phenanthroline-1-yl, 2,9-phenanthroline-3-yl, 2,9-phenanthroline-4-yl, 2,9-phenanthroline-5-yl, 2,9-phenanthroline-6-yl, 2,9-phenanthroline-7-yl, 2,9-phenanthroline-8-yl, 2,9-phenanthroline-10-yl, 2,8-phenanthroline-1-yl, 2,8-phenanthroline-3-yl, 2,8-phenanthroline-4-yl, 2,8-phenanthroline-5-yl, 2,8-phenanthroline-6-yl, 2,8-phenanthroline-7-yl, 2,8-phenanthroline-9-yl, 2,8-phenanthroline-10-yl, 2,7-phenanthroline-1-yl, 2,7-phenanthroline-3-yl, 2,7-phenanthroline-4-yl, 2,7-phenanthroline-5-yl, 2,7-phenanthroline-6-yl, 2,7-phenanthroline-8-yl, 2,7-phenanthroline-9-yl, 2,7-phenanthroline-10-yl, 1-phenazinyl, 2-phenazinyl, 1-phenothiazinyl, 2-phenothiazinyl, 3-phenothiazinyl, 4-phenothiazinyl, 1-phenoxazinyl, 2-phenoxazinyl, 3-phenoxazinyl, 4-phenoxazinyl, 2-oxazolyl, 4-oxazolyl, 5-oxazolyl, 2-oxadiazolyl, 5-oxadiazolyl, 3-furazanyl, 2-thienyl, 3-thienyl, 2-methylpyrrole-1-yl, 2-methylpyrrole-3-yl, 2-methylpyrrole-4-yl, 2-methylpyrrole-5-yl, 3-methylpyrrole-1-yl, 3-methylpyrrole-2-yl, 3-methylpyrrole-4-yl, 3-methylpyrrole-5-yl, 2-t-butylpyrrole-4-yl, 3-(2-phenylpropyl)pyrrole-1-yl, 2-methyl-1-indolyl, 4-methyl-1-indolyl, 2-methyl-3-indolyl, 4-methyl-3-indolyl, 2-t-butyl-1-indolyl, 4-t-butyl-1-indolyl, 2-t-butyl-3-indolyl, and 4-t-butyl-3-indolyl groups.

Examples of the substituted or unsubstituted heterocyclic, alkyl and cycloalkyl groups of R⁶ to R¹³ are the same as the above examples for Y.

The substituted or unsubstituted alkoxy groups of R⁶ to R¹³ are represented by —OQ. Examples of Q are the same as the above substituted or unsubstituted alkyl groups for Y.

Examples of the substituted or unsubstituted aralkyl group of R⁶ to R¹³ include benzyl, 1-phenylethyl, 2-phenylethyl, 1-phenylisopropyl, 2-phenylisopropyl, phenyl-t-butyl, α-naphthylmethyl, 1-α-naphthylethyl, 2-α-naphthylethyl, 1-α-naphthylisopropyl, 2-α-naphthylisopropyl, β-naphthylmethyl, 1-β-naphthylethyl, 2-β-naphthylethyl, 1-β-naphthylisopropyl, 2-β-naphthylisopropyl, 1-pyrrolylmethyl, 2-(1-pyrrolyl)ethyl, p-methylbenzyl, m-methylbenzyl, o-methylbenzyl, p-chlorobenzyl, m-chlorobenzyl, o-chlorobenzyl, p-bromobenzyl, m-bromobenzyl, o-bromobenzyl, p-iodobenzyl, m-iodobenzyl, o-iodobenzyl, p-hydroxybenzyl, m-hydroxybenzyl, o-hydroxybenzyl, p-aminobenzyl, m-aminobenzyl, o-aminobenzyl, p-nitrobenzyl, m-nitrobenzyl, o-nitrobenzyl, p-cyanobenzyl, m-cyanobenzyl, o-cyanobenzyl, 1-hydroxy-2-phenylisopropyl, 1-chloro-2-phenylisopropyl, and trityl groups.

The electron-transporting material or the host material is preferably a compound having at least one group selected from a carbazolyl group and a tetrahydrocarbazolyl group. The electron-transporting material or the host material is still more preferably a compound having one or two groups selected from a carbazolyl group and a tetrahydrocarbazolyl group. The electron-transporting material or the host material may further have a nitrogen-containing hetero ring group.

Further detailed examples of the compound shown by the formula (4) are disclosed in Japanese Patent Application No. 2002-305375.

The electron-transporting material or the host material may be a compound having one of the following structures. 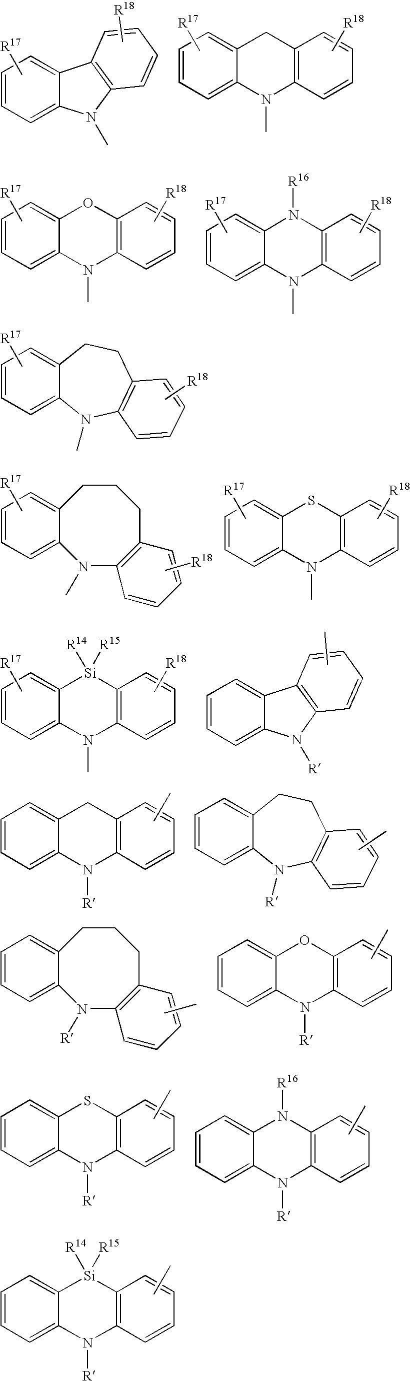
R¹⁴ to R¹⁸ individually represent a hydrogen atom or a substituent having 1 to 40 carbon atoms, provided that R¹⁴ and R¹⁵ may bond to form a saturated or unsaturated cyclic structure, and R′ represents an alkyl group or an aryl group.

The alkyl group represented by R′ is preferably a methyl group or an ethyl group. The aryl group represented by R′ is preferably a phenyl group.

The electron-transporting material or the host material may be an organic compound shown by the following formula (5). 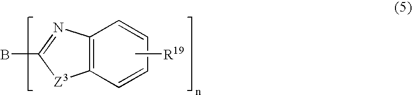
wherein n represents an integer from 3 to 8, Z³ represents O, NR²⁰, or S, R¹⁹ and R²⁰ individually represent a hydrogen atom, an alkyl group having 1 to 24 carbon atoms such as a propyl group, t-butyl group, or heptyl group, an aryl group or a hetero atom-substituted aryl group having 5 to 20 carbon atoms such as a phenyl group, naphthyl group, furyl group, thienyl group, pyridyl group, quinolyl group, or another heterocyclic ring group, a halogen group such as a chloro group or fluoro group, or an atom necessary to complete a condensed aromatic ring, and B represents a bond unit formed of an alkyl group, aryl group, substituted alkyl group, or substituted aryl group which bonds a plurality of benzazoles in a conjugated or nonconjugated manner.

Benzimidazole derivatives disclosed in Japanese Patent Application No. 2003-067847, metal complexes disclosed in U.S. Pat. No. 5,141,671, and the like may also be used.

A compound having a carbazolyl group can also be given as a preferable electron-transporting material. An organic compound having a carbazolyl group and a substituted or unsubstituted pyridyl group, pyrazyl group, pyrimidyl group, triazyl group, amino group, or oxadizole group is more preferable.

As specific examples of such a compound, compounds disclosed in Japanese Patent Application Nos. 2002-071398, 2002-081234, 2002-071397, 2002-080817, 2002-305375, 2002-360134, and the like can be given.

Examples of the compound having a carbazolyl group are given below.

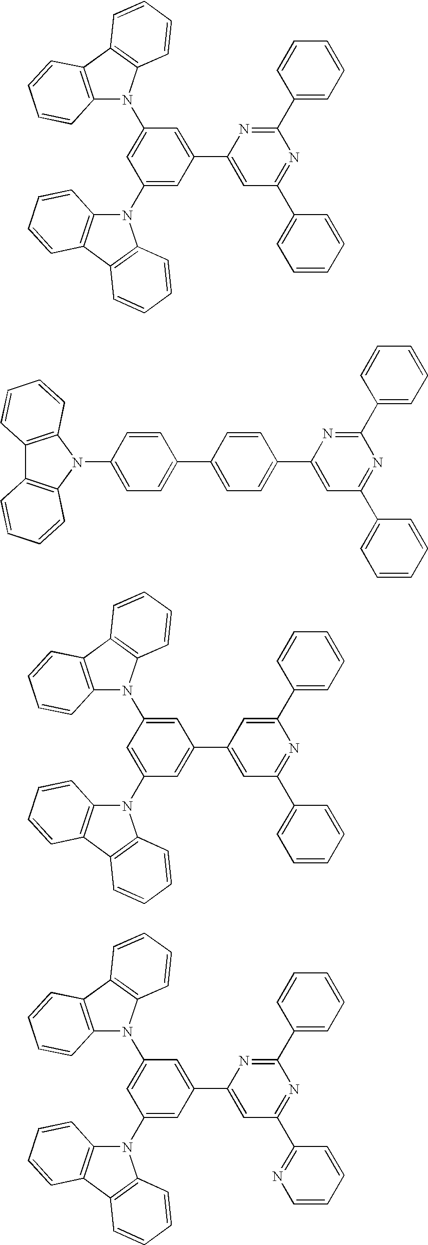

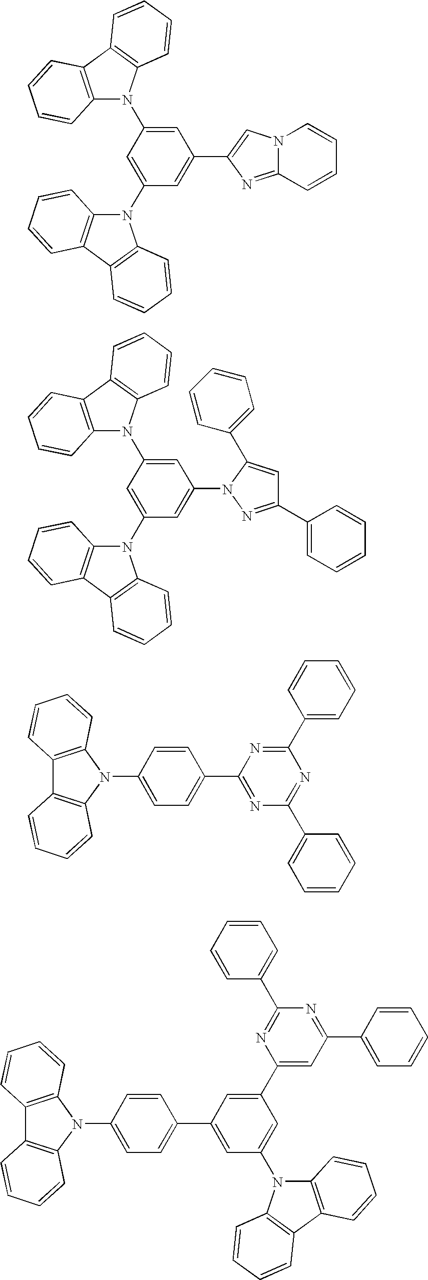

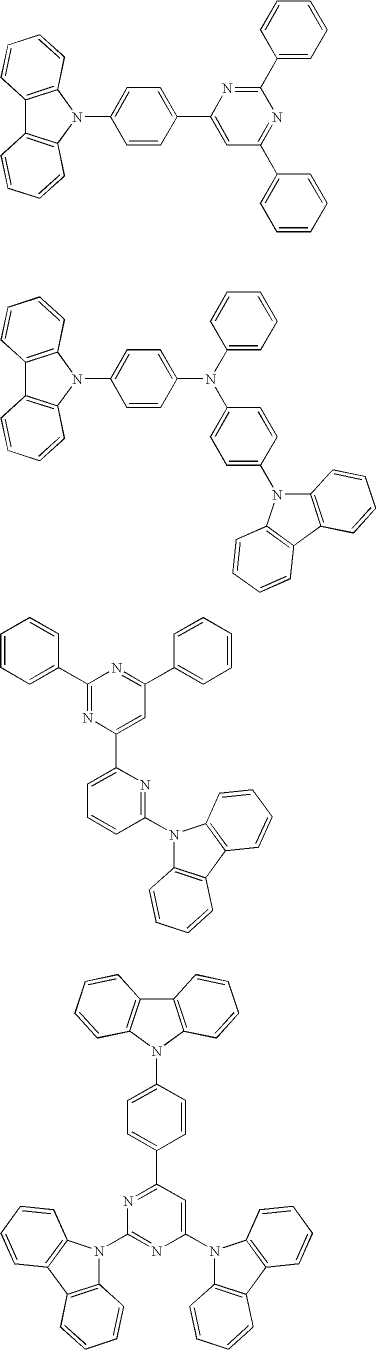

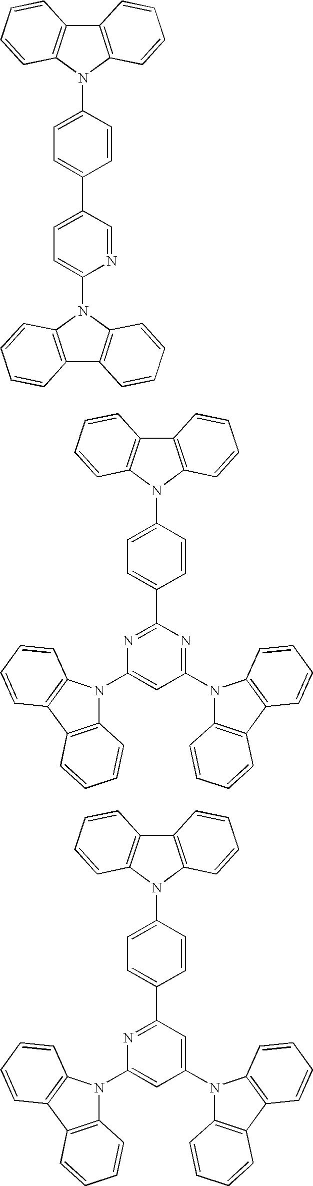

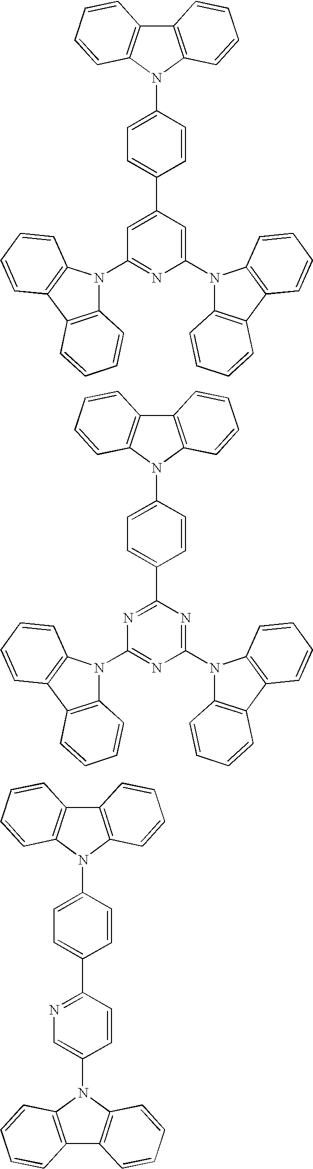

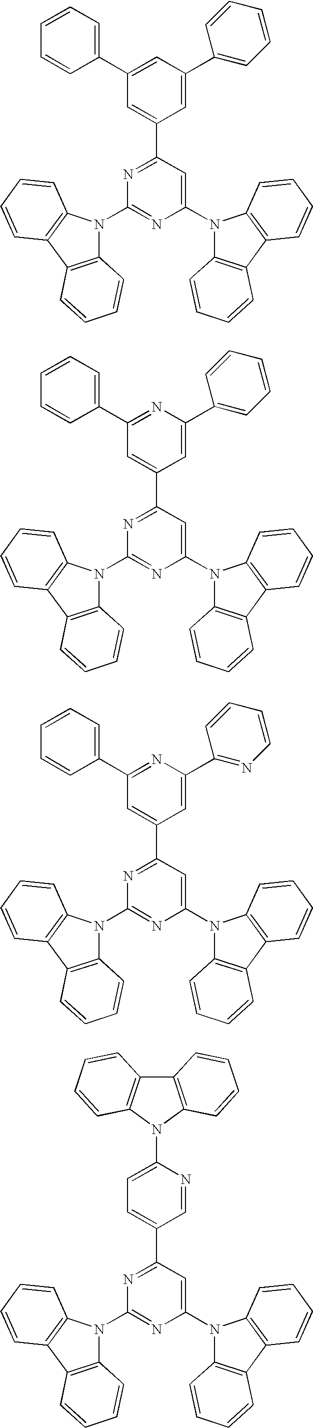

Compounds having one carbazolyl group and compounds having one carbazolyl group and a nitrogen-containing hetero ring group disclosed in Japanese Patent Application No. 2002-299810 are also preferable. Each of the carbazolyl group and the nitrogen-containing hetero ring group may or may not be substituted.

A compound shown by the following formula can be given as such a compound.
Cz-A
wherein Cz represents a substituted or unsubstituted arylcarbazolyl group or carbazolylalkylene group, and A represents a group shown by the following formula.
(M)p-(E)q-(M′)r
wherein M and M′ individually represent nitrogen-containing heteroaromatic rings having 2 to 40 carbon atoms which form a substituted or unsubstituted ring, M and M′ may be the same or different, E represents a single bond, a substituted or unsubstituted arylene group having 6 to 30 carbon atoms, substituted or unsubstituted cycloalkylene group having 5 to 30 carbon atoms, or substituted or unsubstituted divalent heteroaromatic ring having 2 to 30 carbon atoms, p represents an integer from 0 to 2, q represents an integer of 1 to 2, and r represents an integer from 0 to 2, provided that “p+r” is one or more.

Note that Cz is bonded to M, E, or M′.

As specific examples of such a compound, ETM_No. 3, ETM_No. 4, ETM_No 5, ETM_No. 10, and ETM_No. 11 described in the examples, and the following compounds having a carbazolyl group and a nitrogen-containing hetero ring group which are given as specific examples in pages 13 to 19 of Japanese Patent Application No. 2002-299810 can be given.

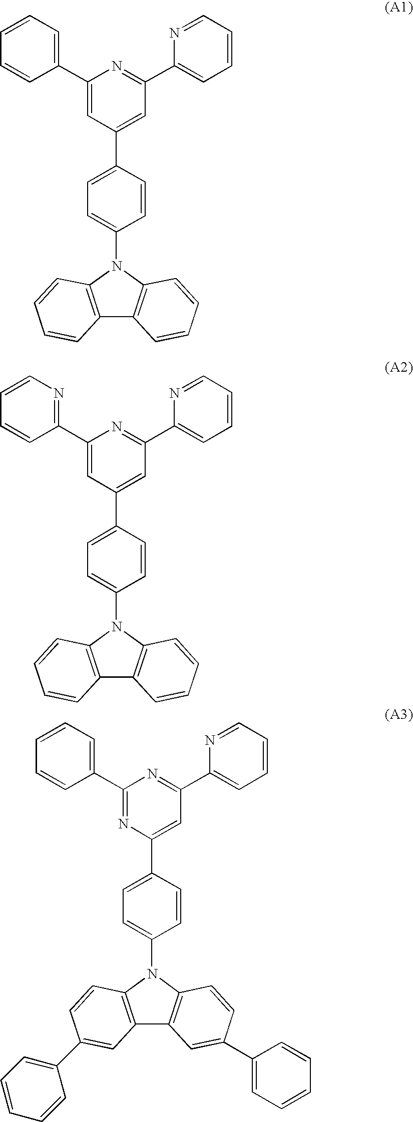

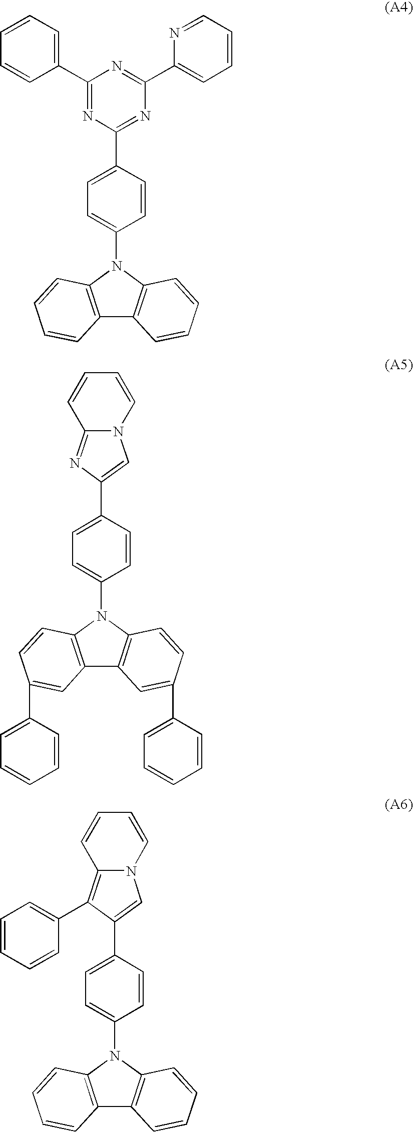

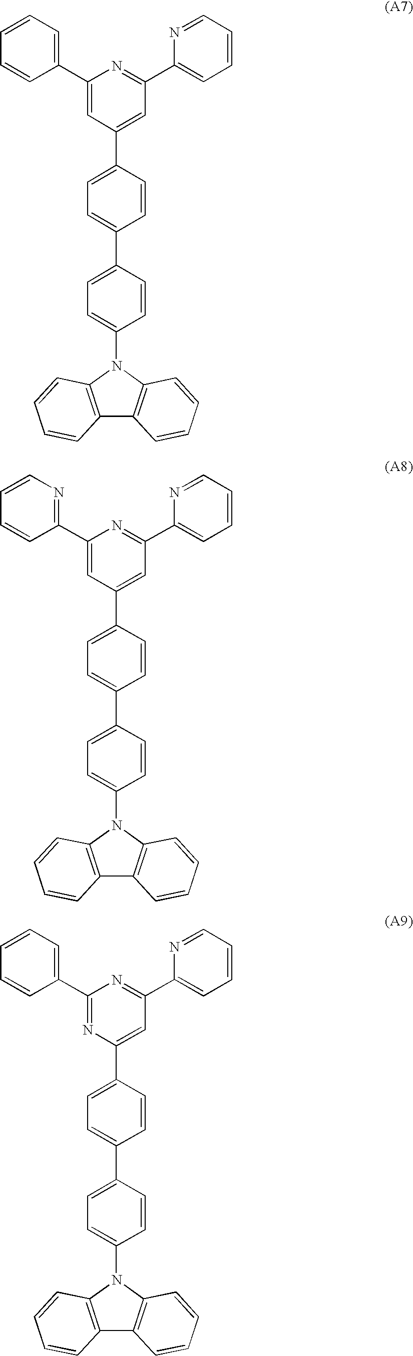

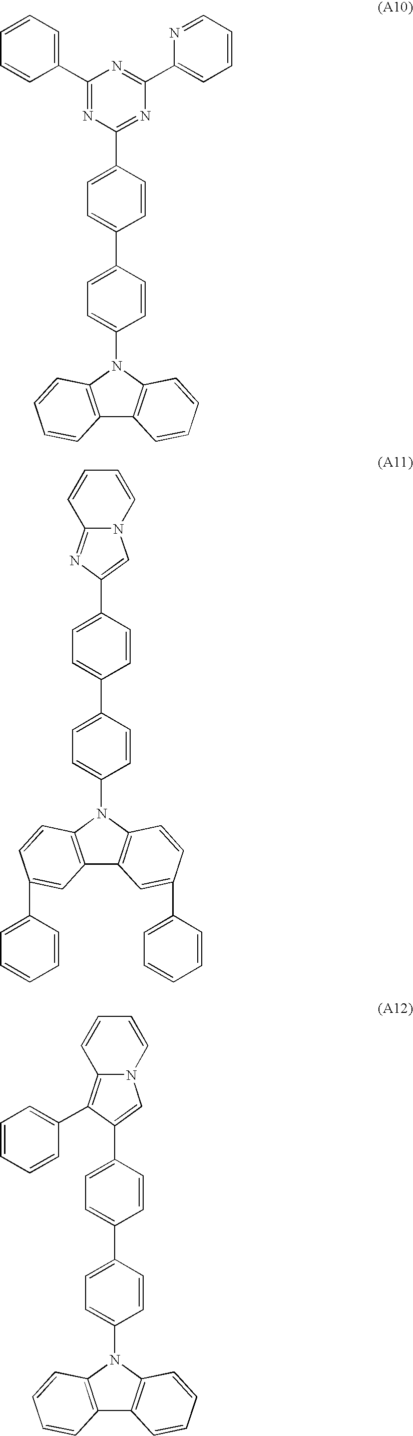

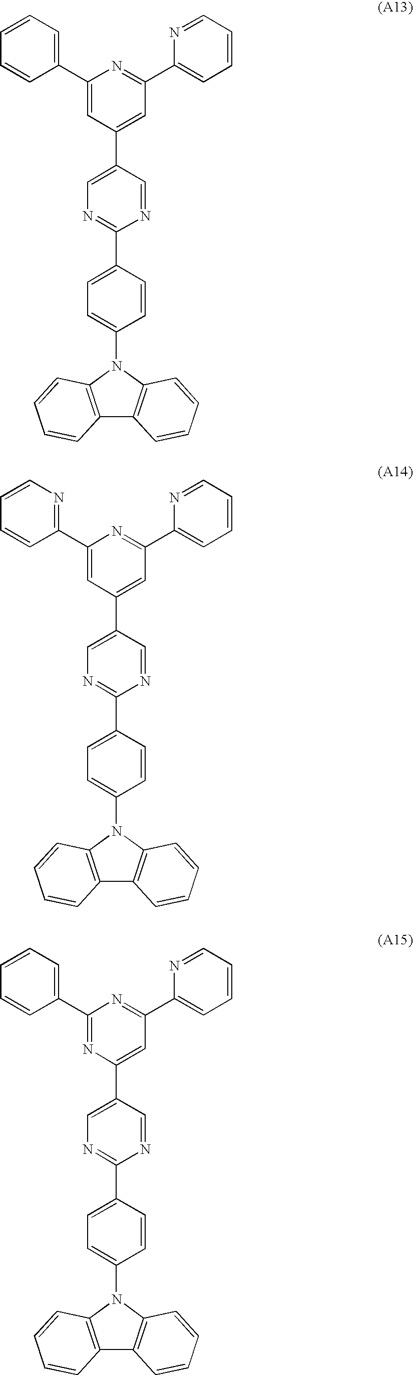

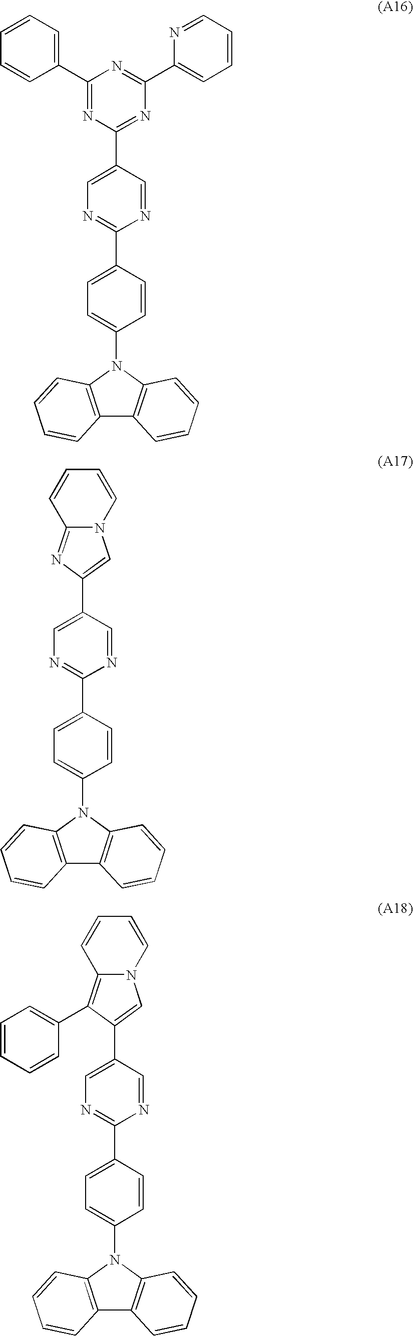

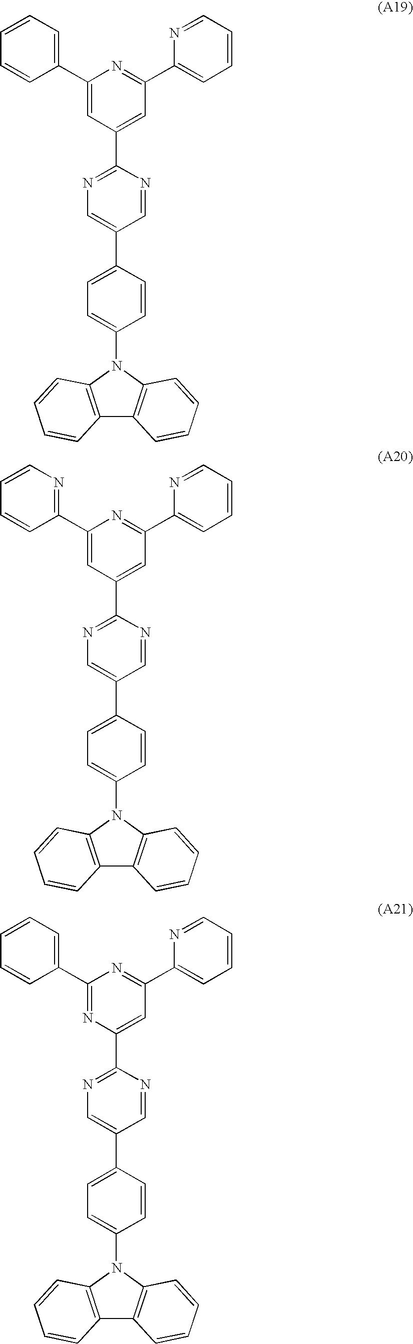

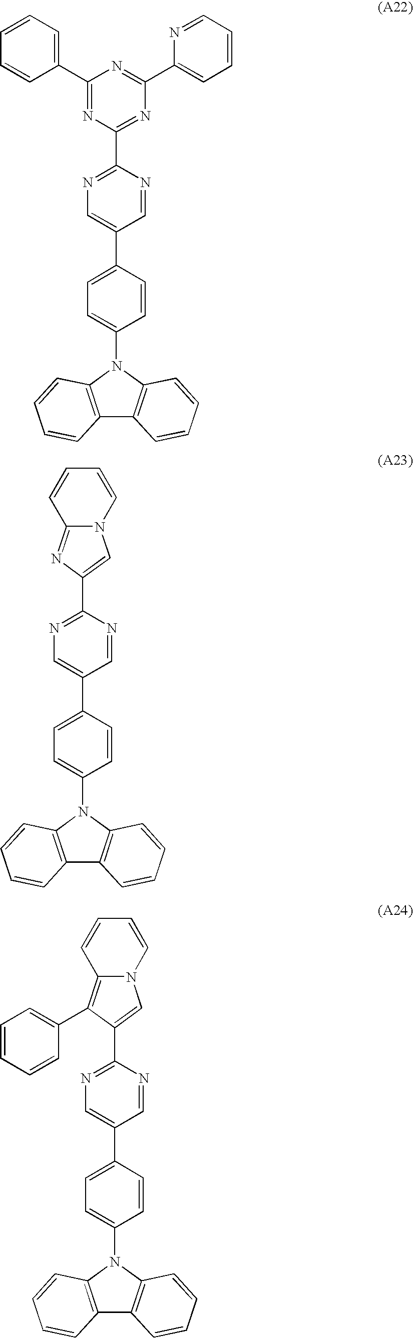

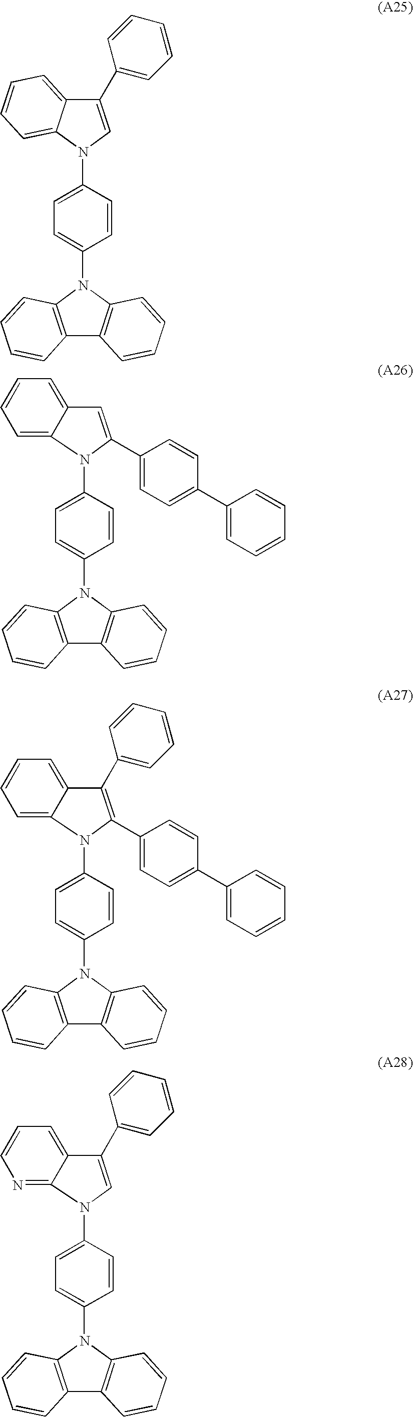

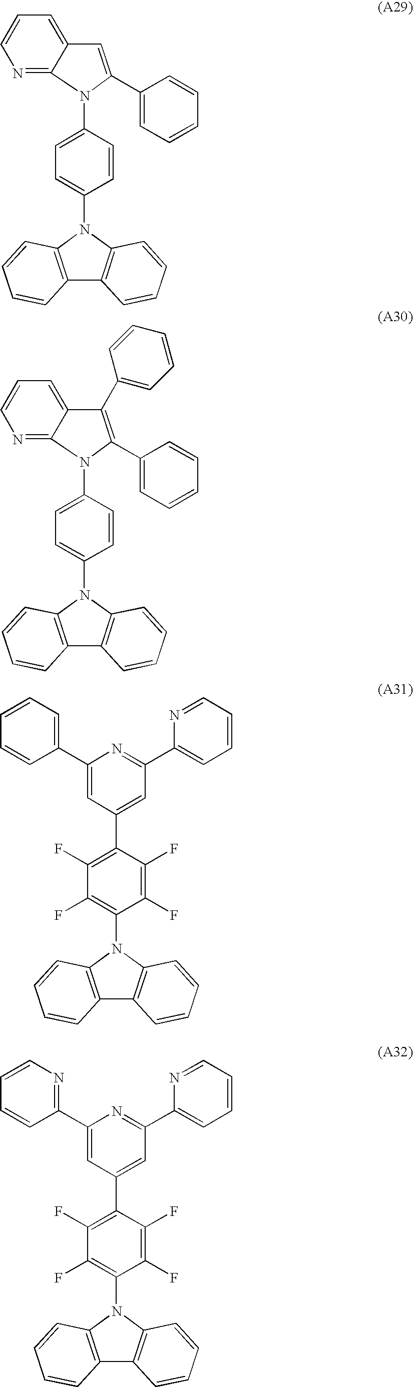

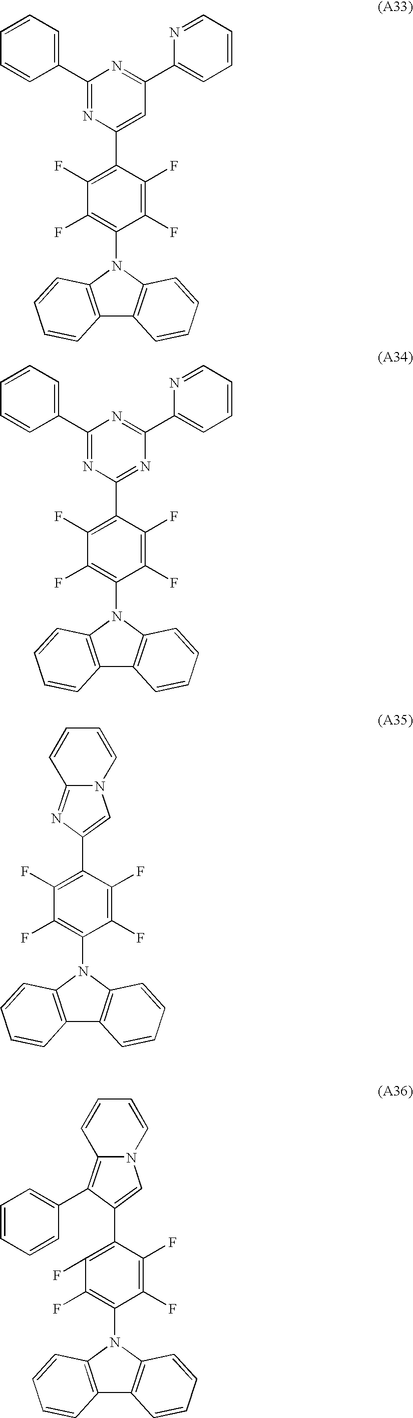

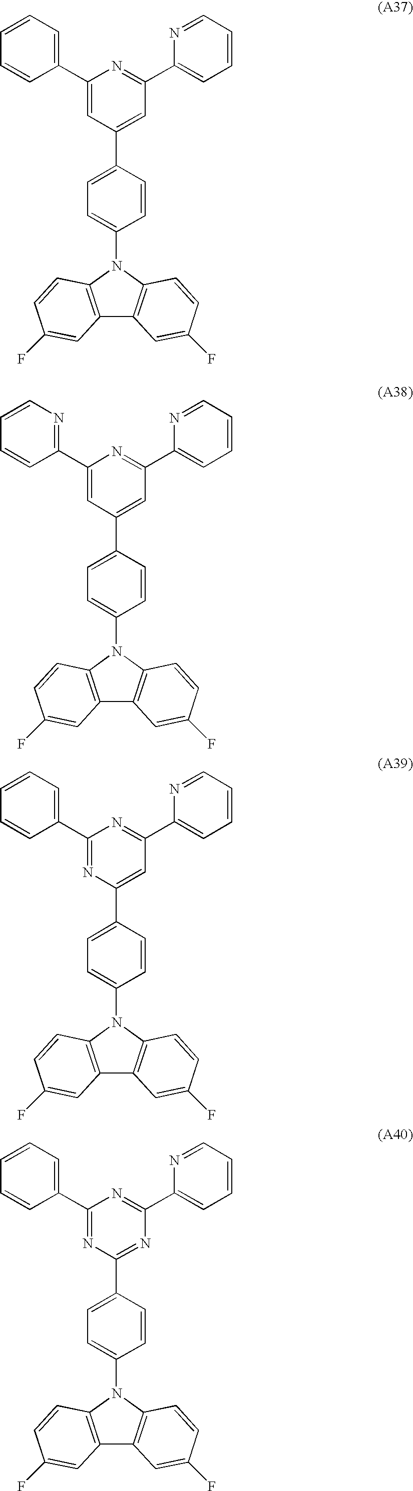

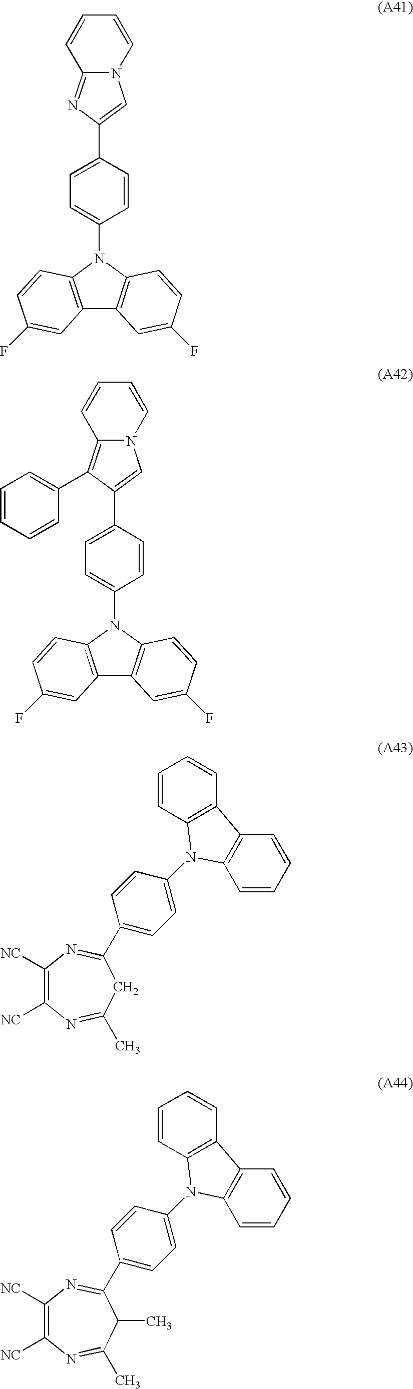

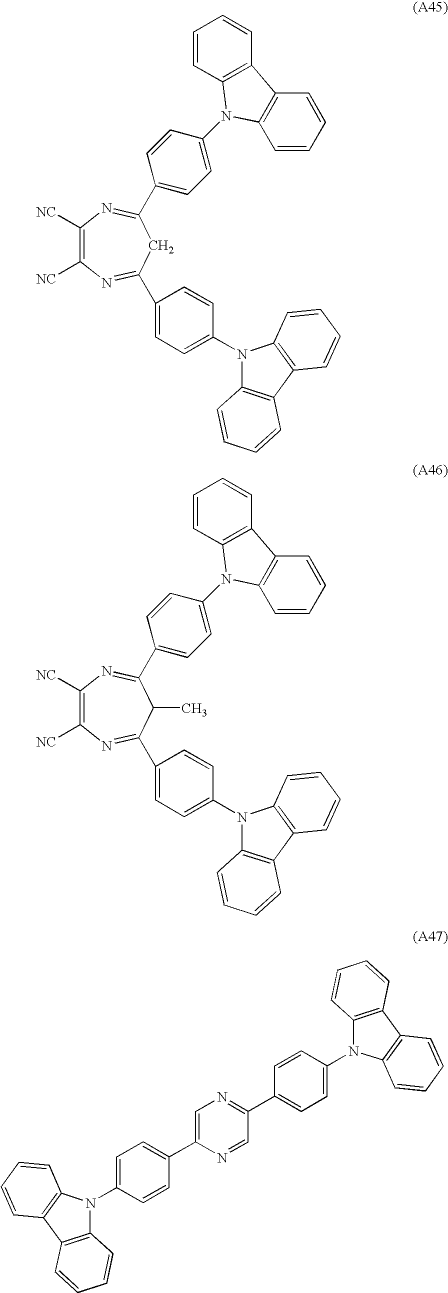

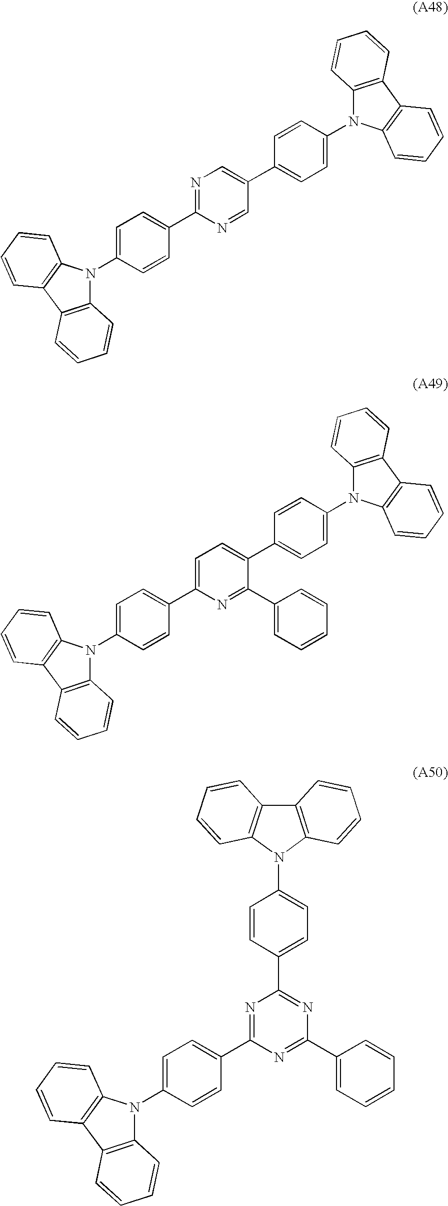

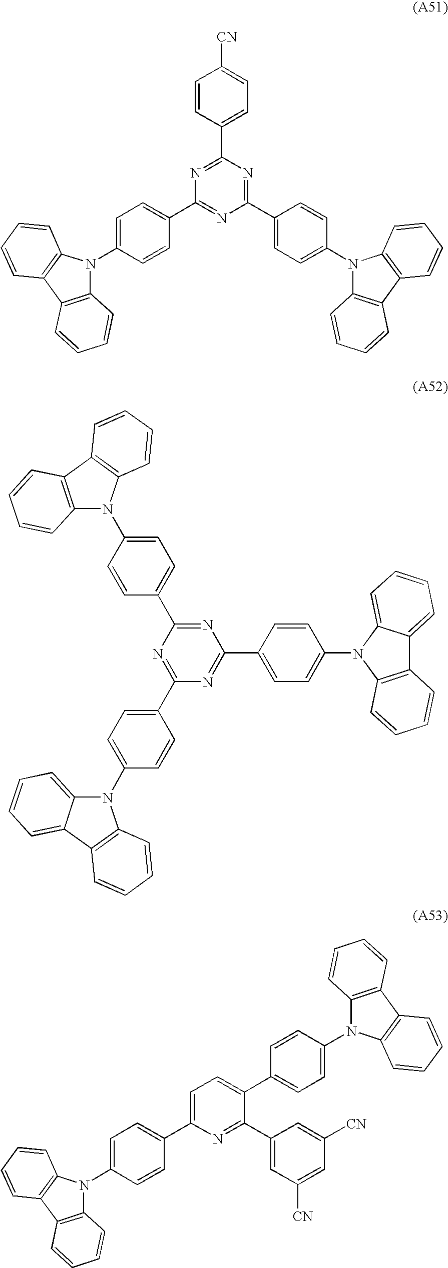

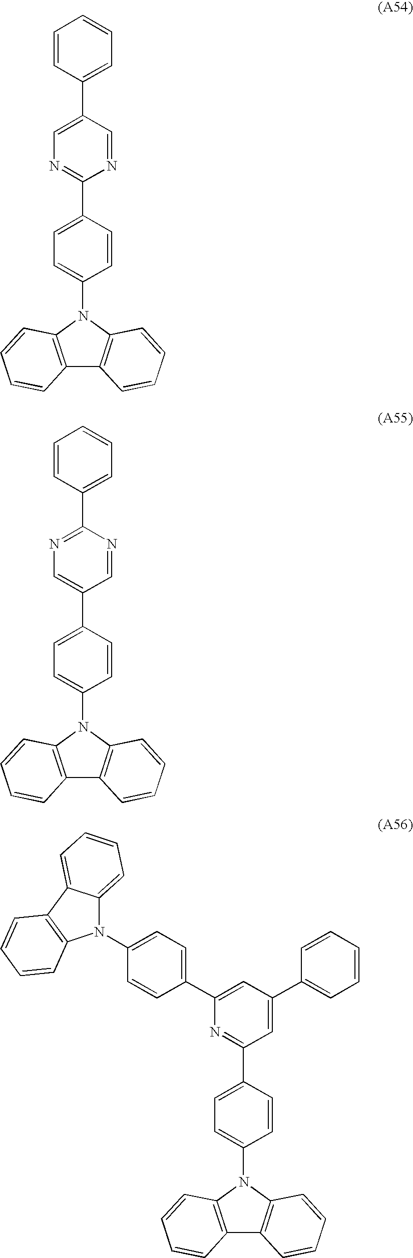

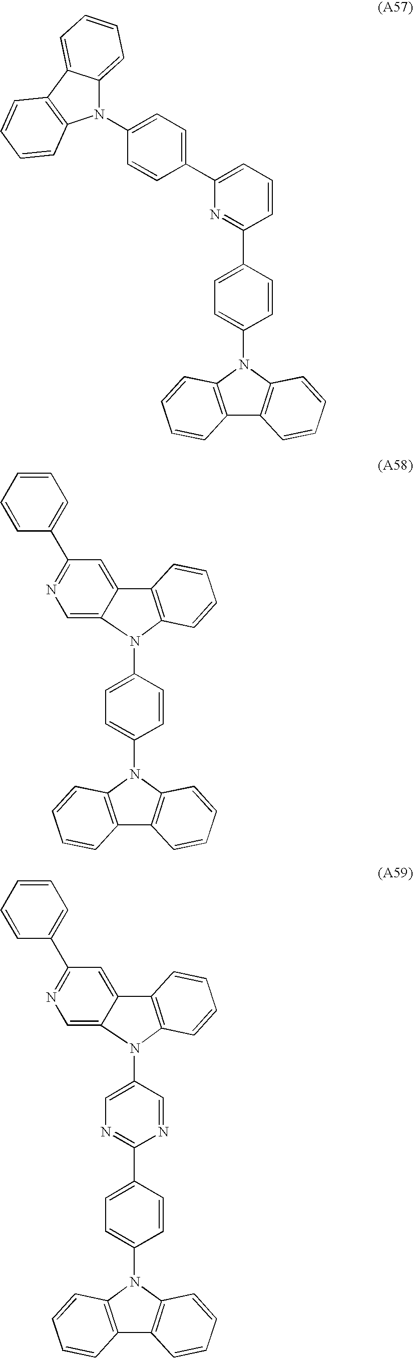

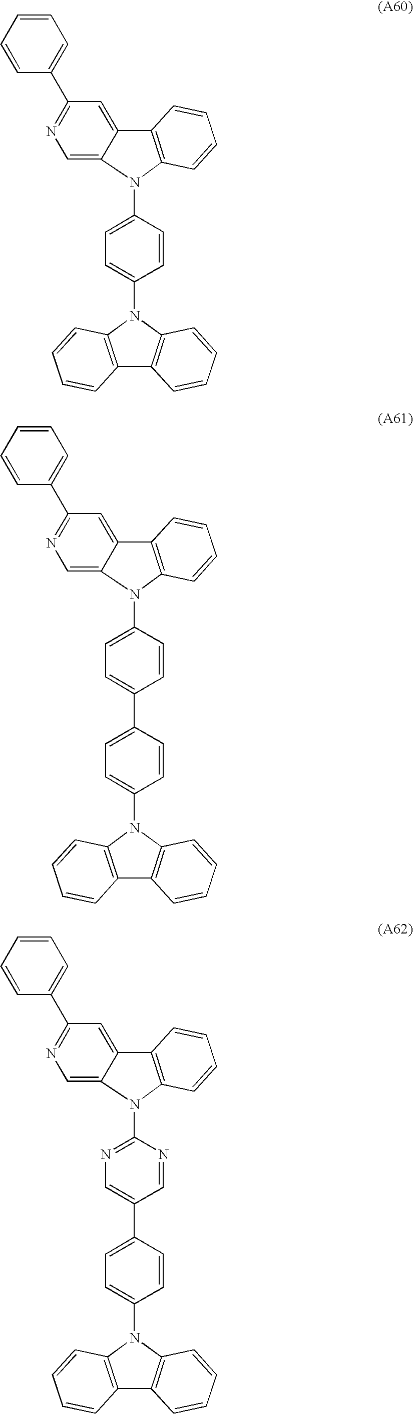

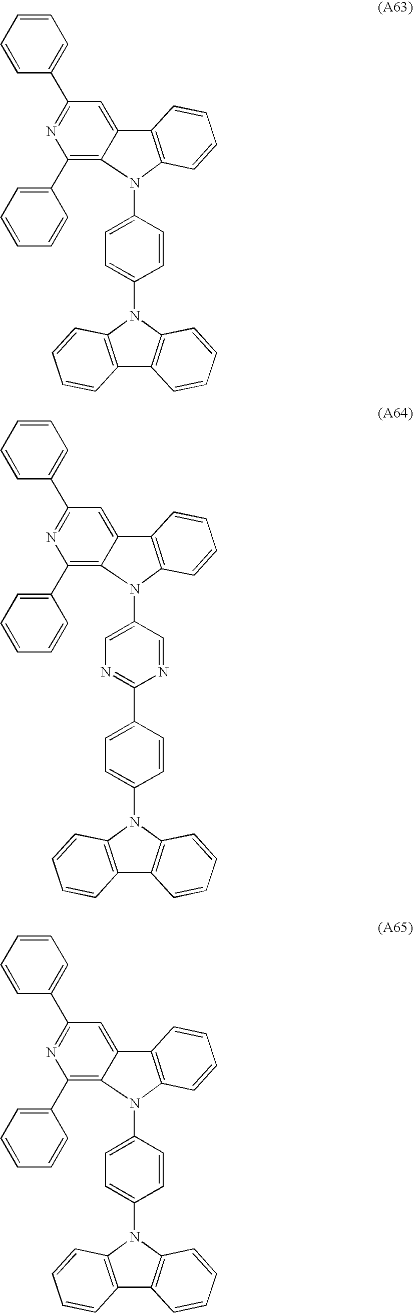

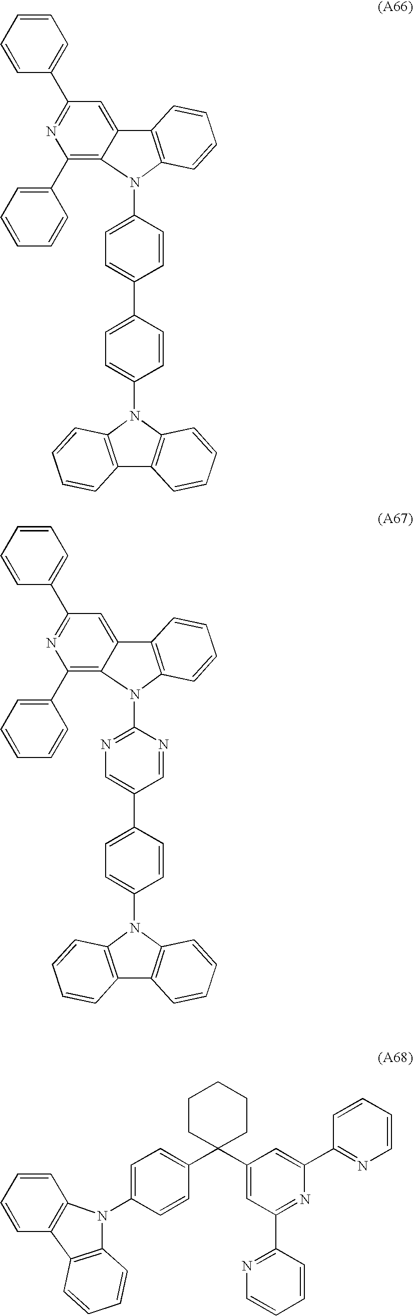

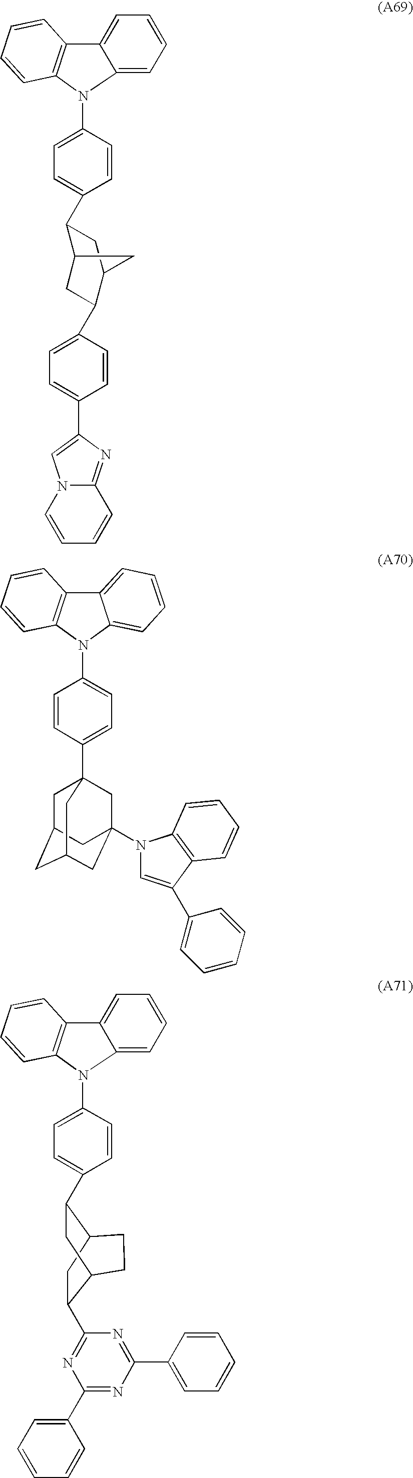

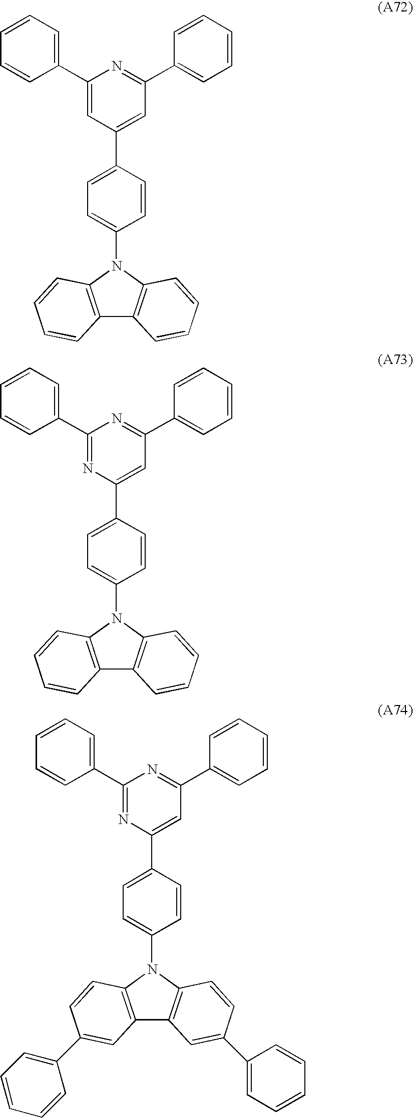

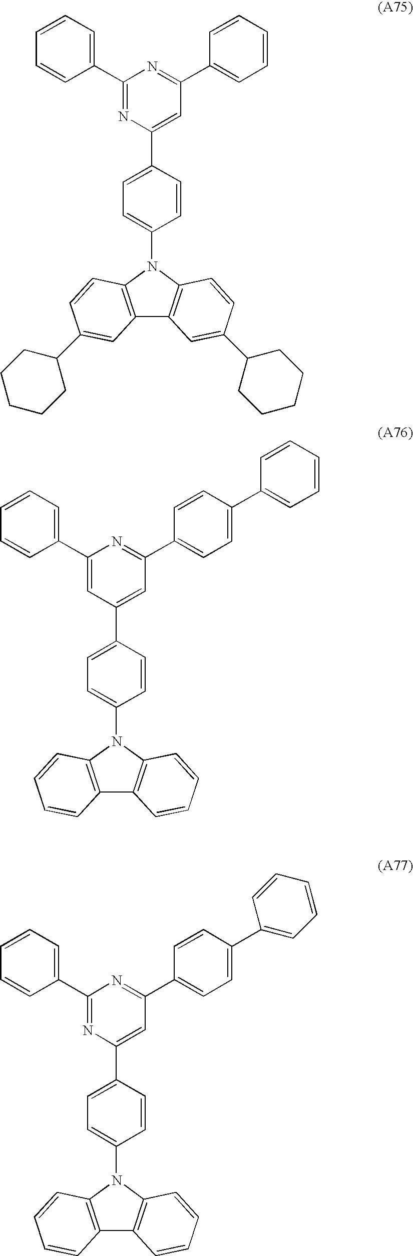

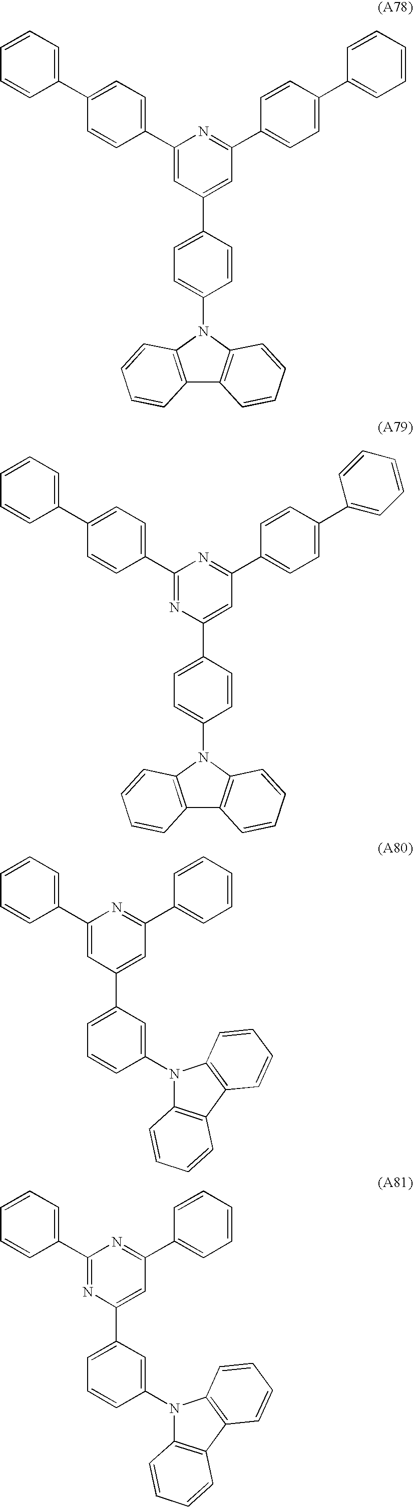

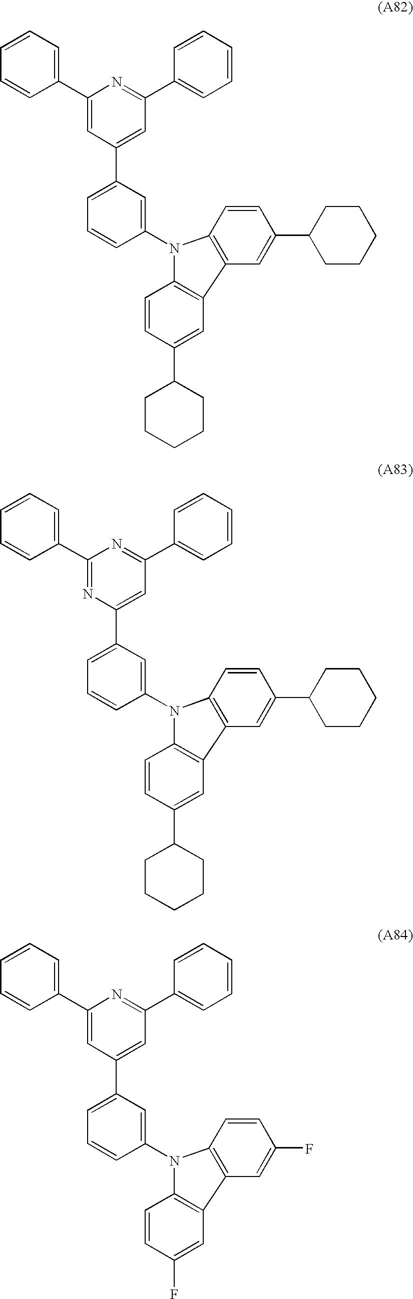

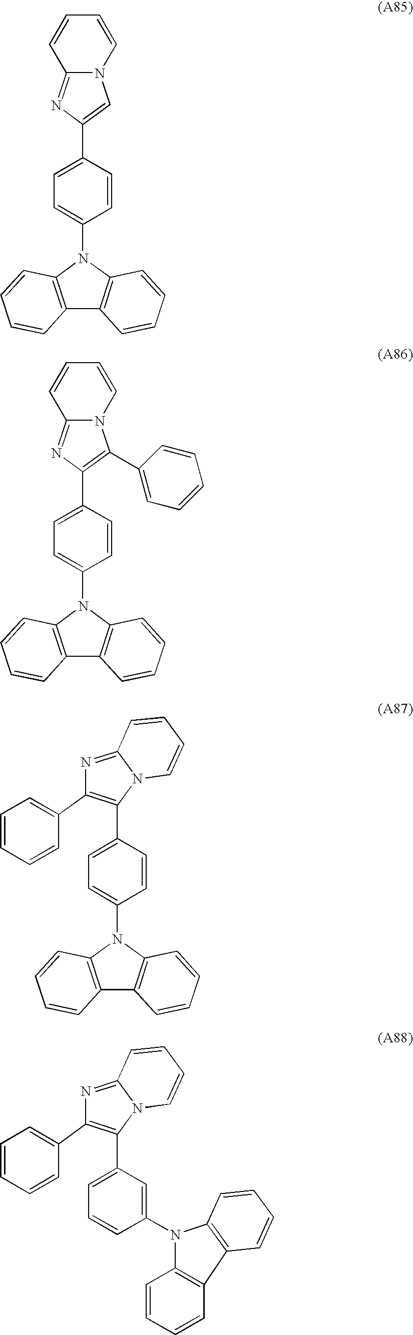

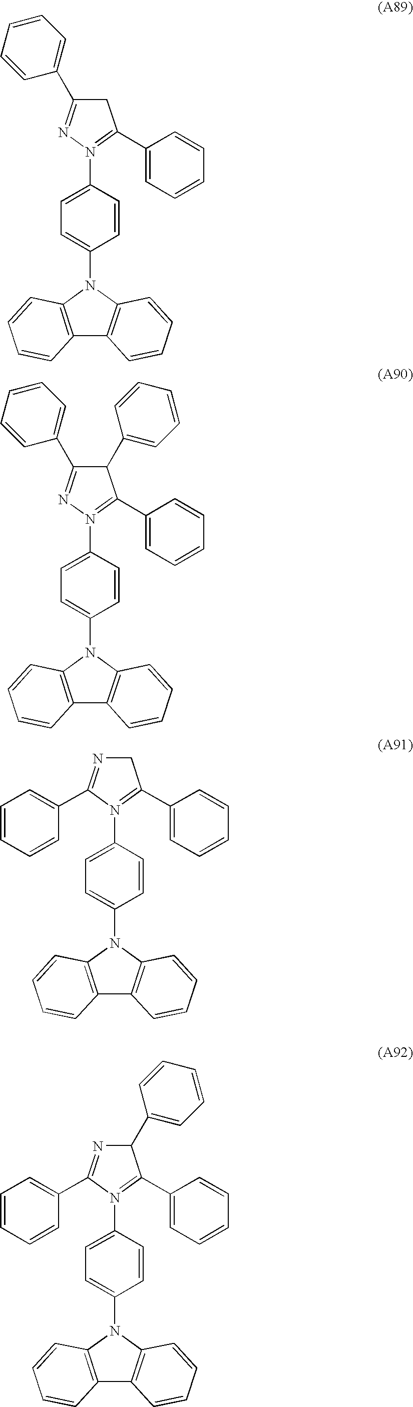

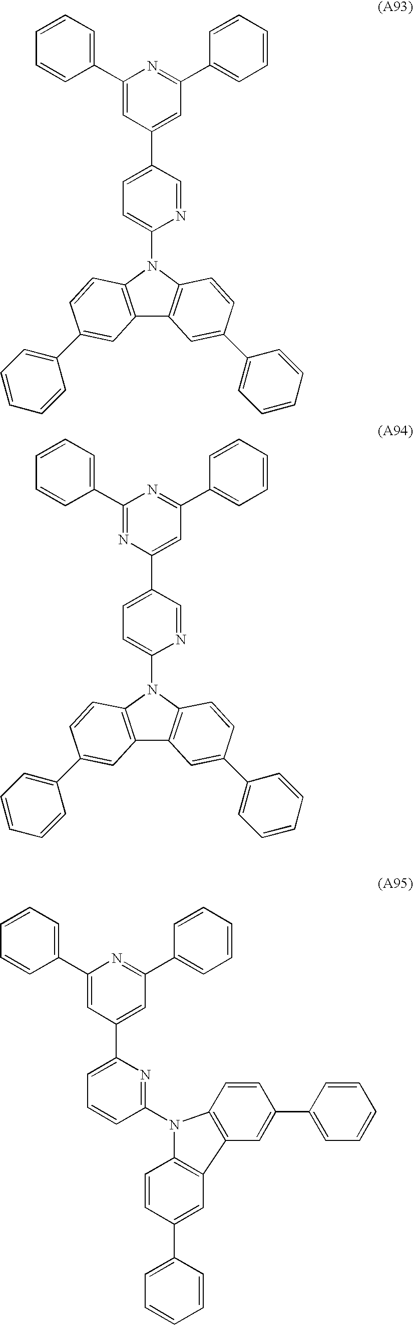

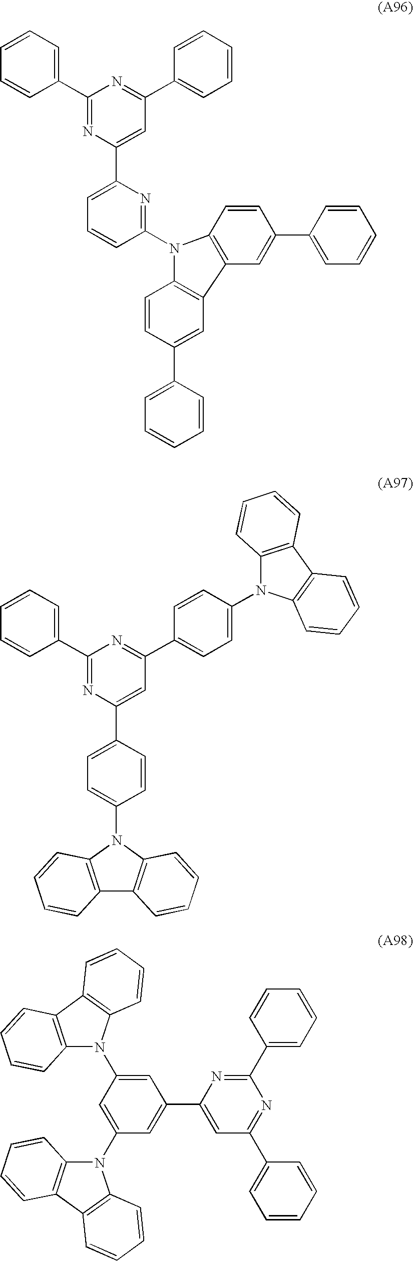

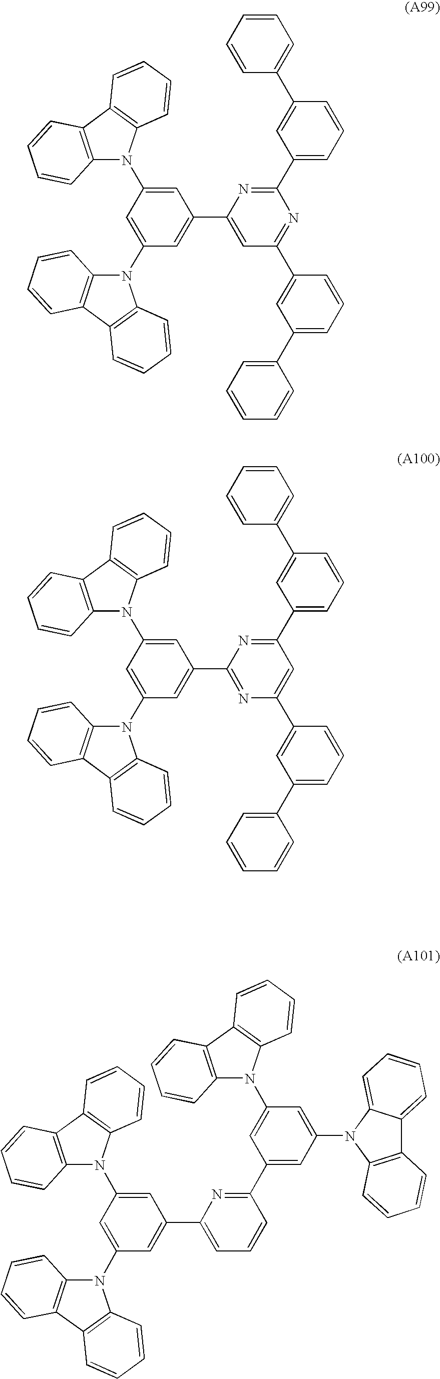

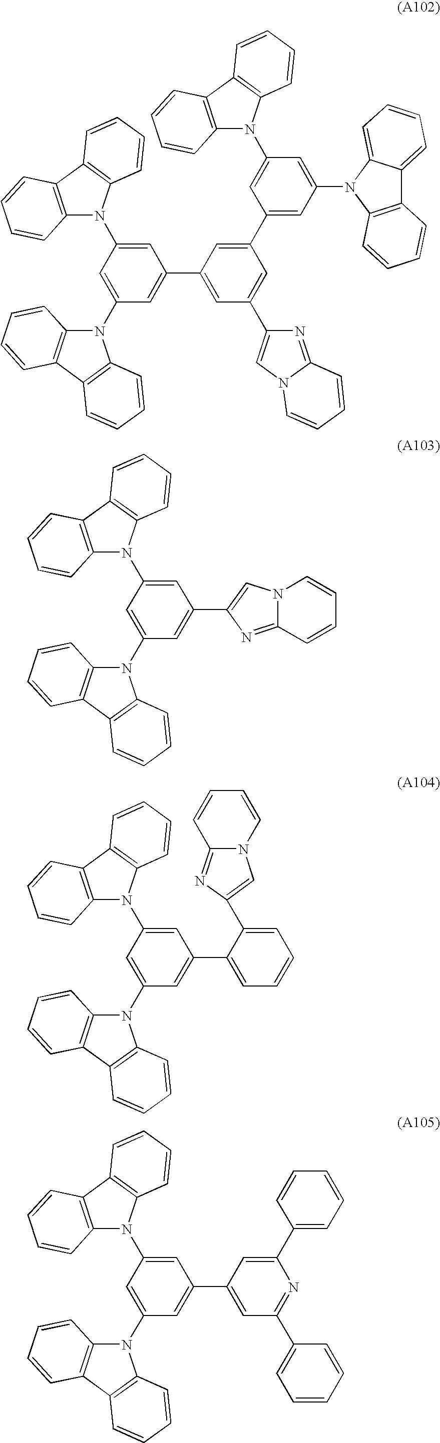

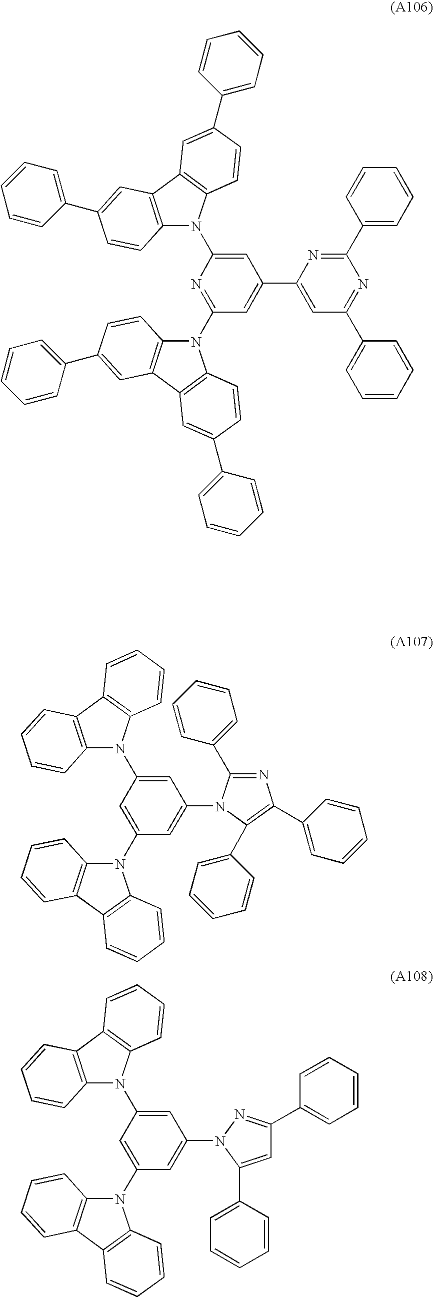

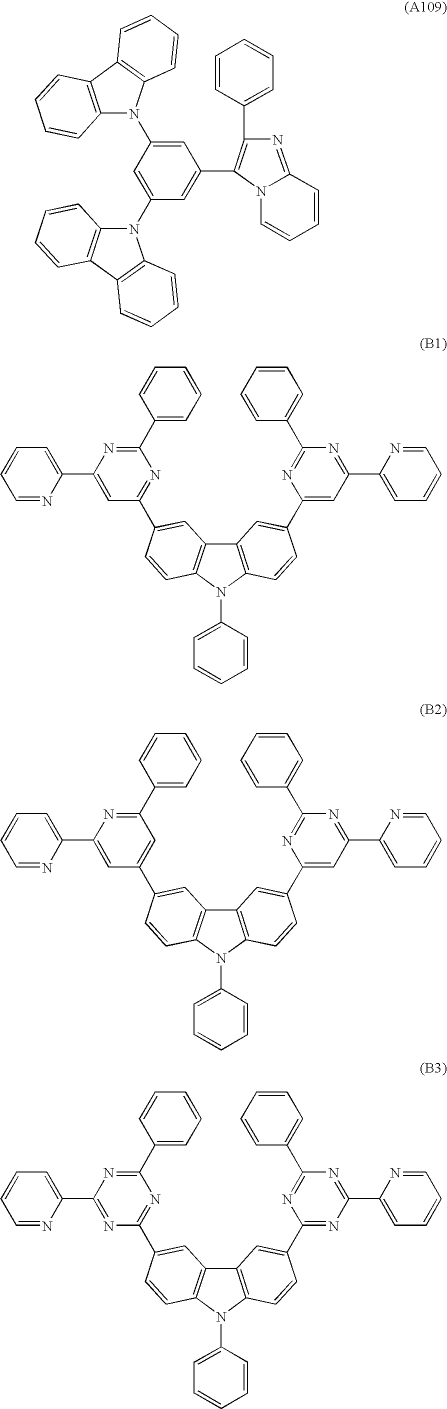

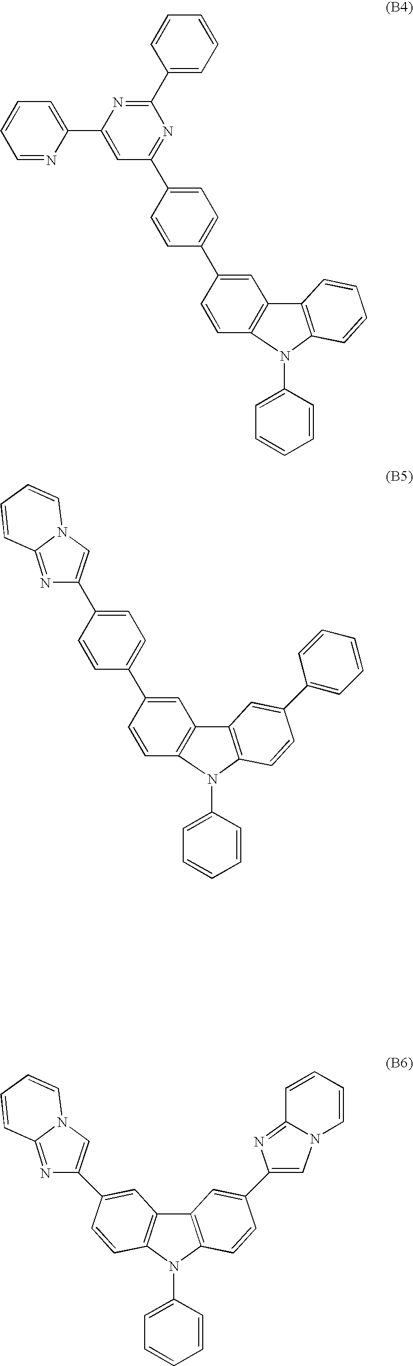

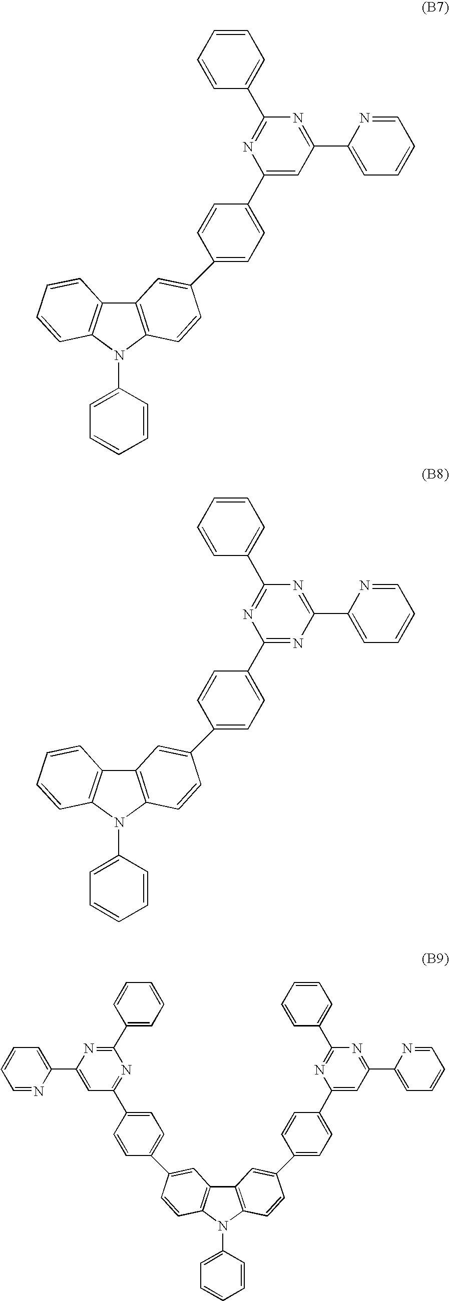

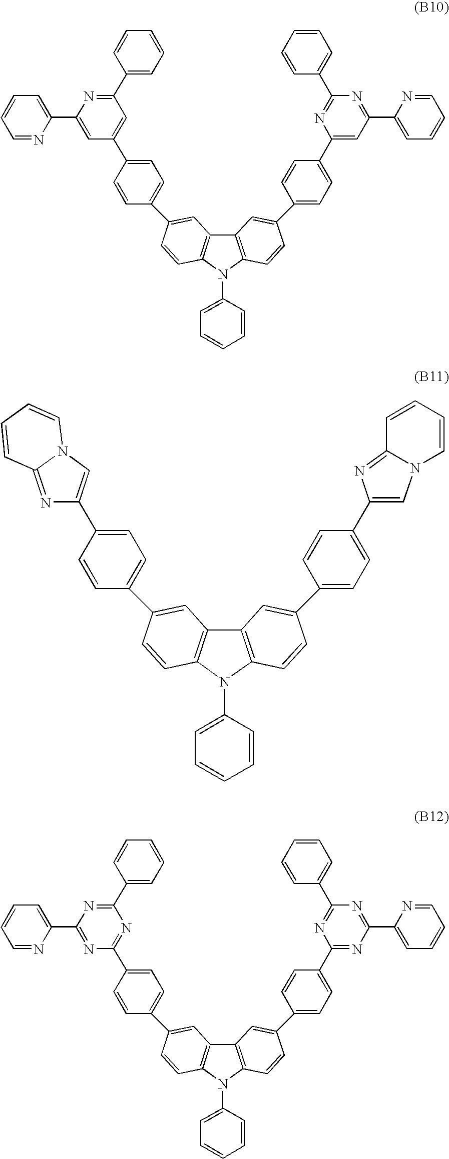

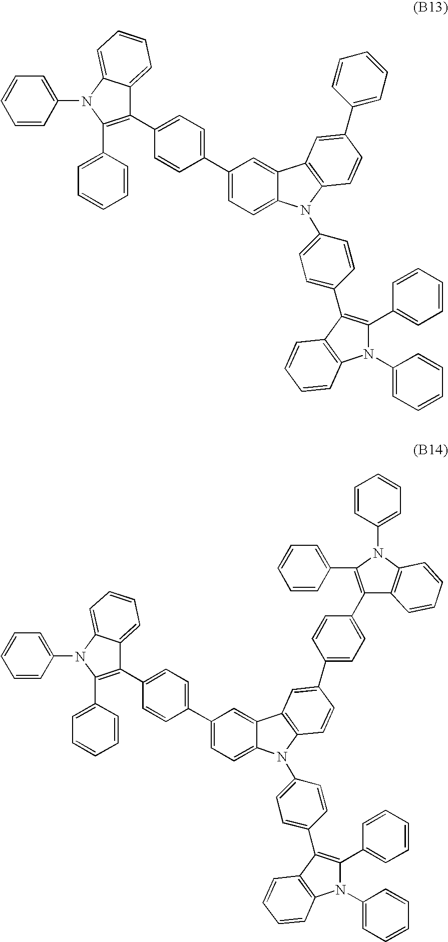

In the invention, any of the electron-transporting materials listed above may be used as the host material for the emitting layer.

As examples of the configuration of the organic EL device according to the invention, the following configurations (a) to (c) can be given.

(a) Anode/emitting layer/electron-transporting layer/cathode

(b) Anode/hole-transporting layer/emitting layer/electron-transporting layer/cathode

(c) Anode/hole-injecting layer/hole-transporting layer/emitting layer/electron-transporting layer/cathode

The emitting layer in the organic EL device according to the invention is a layer obtained by adding a luminescent dopant to the above-described host material. The concentration of the luminescent dopant added to the host material is not particularly limited. The concentration of the luminescent dopant is preferably 0.1 to 20 wt %, and still more preferably 1 to 15 wt % from the viewpoint of current efficiency and drive voltage adjustment.

The organic EL device according to the invention is preferably supported by a substrate. The layers may be stacked on the substrate in the order from the anode to the cathode, or may be stacked on the substrate in the order from the cathode to the anode.

It is preferable that at least one of the anode and the cathode be formed of a transparent or translucent substance in order to efficiently outcouple light from the emitting layer.

The material for the substrate used in the invention is not particularly limited. A known material used for an organic EL device such as glass, transparent plastic, or quartz may be used.

As the material for the anode used in the invention, a metal, alloy, or electric conductive compound having a work function as large as 4 eV or more, or a mixture of these materials is preferably used. As specific examples of such a material, metals such as Au and dielectric transparent materials such as CuI, ITO, SnO₂, and ZnO can be given.

The anode may be formed by forming a thin film of the above-mentioned material by deposition, sputtering method, or the like.

When outcoupling light from the emitting layer through the anode, it is preferable that the anode have a transparency of more than 10%.

The sheet resistance of the anode is preferably several hundreds ohm/square or less.

The thickness of the anode is usually 10 nm to 1 micron, and preferably 10 to 200 nm, although the thickness varies depending on the material.

As the material for the cathode used in the invention, a metal, alloy, or electric conductive compound having a work function as small as 4 eV or less, or a mixture of these materials is preferably used. As specific examples of such a material, sodium, lithium, aluminum, magnesium/silver mixture, magnesium/copper mixture, Al/Al₂O₃, indium, and the like can be given.

The cathode may be formed by forming a thin film of the above-mentioned material by deposition, sputtering method, or the like.

When outcoupling light from the emitting layer through the cathode, it is preferable that the cathode have a transparency of more than 10%.

The sheet resistance of the cathode is preferably several hundreds ohm/square or less.

The thickness of the cathode is usually 10 nm to 1 micron, and preferably 50 to 200 nm, although the thickness varies depending on the material.

In the organic EL device according to the invention, a hole-injecting layer, a hole-transporting layer, an electron-injecting layer, and the like may be provided, as required, in order to further increase the current (or luminous) efficiency. The materials for these layers are not particularly limited. A known organic material for an organic EL may be used. As specific examples of such a material, amine derivatives, stilbene derivatives, silazane derivatives, polysilane, aniline copolymers, and the like can be given.

In the invention, it is preferable to add an inorganic material to the hole-injecting layer, the hole-transporting layer, and the electron-injecting layer. As examples of the inorganic material, metal oxides and the like can be given.

An inorganic material may be used between the electron-transporting layer and the cathode in order to increase the current (or luminous) efficiency. As specific examples of the inorganic material, fluorides and oxides of alkali metals such as Li, Mg, and Cs can be given.

The method of fabricating the organic EL device according to the invention is not particularly limited. The organic EL device according to the invention may be fabricated using a fabrication method used for a known organic EL device. In more detail, each layer may be formed by vacuum deposition, casting, coating, spin coating, or the like. Each layer may be formed by casting, coating, or spin coating using a solution prepared by dispersing an organic material for each layer in a transparent polymer such as polycarbonate, polyurethane, polystyrene, polyallylate, or polyester, or each layer may be formed by simultaneous deposition of an organic material and a transparent polymer.

### EXAMPLES

The invention is described below in more detail by way of examples. Note that the invention is not limited to the following examples.

Compounds used in the examples were produced by the methods disclosed in JP-A-10-237438, Japanese Patent Application Nos. 2003-042625, 2002-071398, 2002-081234, 2002-299814, 2002-360134, 2002-071397, 2002-080817, 2002-083866, 2002-087560, and 2002-305375.

The parameters shown in the tables were measured by the following methods.

(1) Ionization Potential (Ip)

Light (excitation light) from a deuterium lamp dispersed by a monochromator was irradiated to a material, and the resulting photoelectric emission was measured using an electrometer. The ionization potential was determined by calculating the photoelectric emission threshold value from the photoelectric emission photon energy curve obtained using an extrapolation method. As the measuring instrument, an atmosphere ultraviolet photoelectron spectrometer “AC-1” (manufactured by Riken Keiki Co., Ltd.) was used.

(2) Optical Energy Gap (Eg)

Light of which the wavelength was resolved was irradiated to a toluene diluted solution of each material, and the optical energy gap was determined by conversion from the maximum wavelength of the absorption spectrum. As the measuring instrument, a spectrophotometer (“U-3400” manufactured by Hitachi, Ltd.) was used.

(3) Triplet Energy Gap (Eg^{T})

The triplet energy gap (Eg^{T} (Dopant)) was determined by the following method. An organic material was measured by a known phosphorescence measurement method (e.g. method described in “The World of Photochemistry” (edited by The Chemical Society of Japan, 1993), page 50). In more detail, an organic material was dissolved in a solvent (sample 10 micromol/l, EPA (diethyl ether:isopentane:ethanol=5:5:2 (volume ratio), each solvent was spectrum grade) to obtain a phosphorescence measurement sample. After cooling the sample placed in a quartz cell to 77 K, excitation light was irradiated to the sample, and the resulting phosphorescence was measured with respect to the wavelength. A tangent was drawn to the rise of the phosphorescence spectrum on the shorter wavelength side, and the value obtained by converting the wavelength into the energy value was taken as the triplet energy gap (Eg^{T}). The triplet energy gap was measured using a “F-4500” fluorescence spectrophotometer (manufactured by Hitachi, Ltd.) and optional low temperature measurement equipment. Note that the measuring instrument is not limited thereto. The triplet energy gap may be measured by combining a cooling device, a low temperature container, an excitation light source, and a light receiving device.

In the examples, the wavelength was converted using the following expression.
Eg(eV)=1239.85/λ_{edge}

The meaning of “λ_{edge}” is as follows. When the phosphorescence spectrum is expressed in which the vertical axis indicates the phosphorescence intensity and the horizontal axis indicates the wavelength, and a tangent is drawn to the rise of the phosphorescence spectrum on the shorter wavelength side, “λ_{edge}” is the wavelength at the intersection of the tangent and the horizontal axis. The unit for “λ_{edge}” is nm.

### Examples 1 to 5

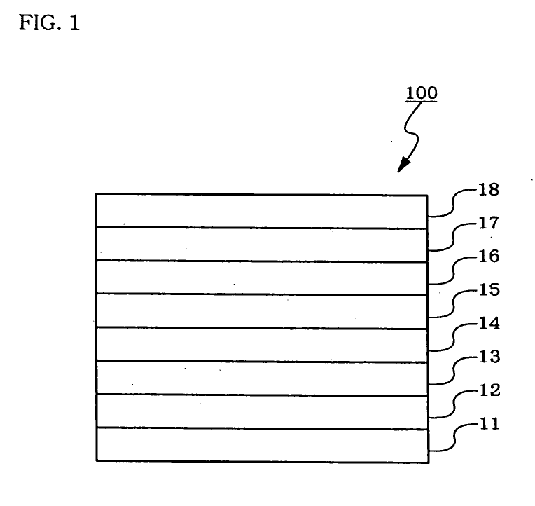

An organic EL device shown in FIG. 1 was fabricated as follows.

A glass substrate 11 (manufactured by Geomatics Co.), measuring 25 mm×75 mm×1.1 mm thick, with an ITO transparent electrode (anode) 12 was subjected to ultrasonic cleaning in isopropyl alcohol for 5 minutes and then to UV ozone cleaning for 30 minutes. The cleaned glass substrate 11 with transparent electrode lines was mounted on a substrate holder in a vacuum deposition device. First, a 100 nm thick film of N,N′-bis(N,N′-diphenyl-4-aminophenyl)-N,N-diphenyl-4,4′-diamino-1,1′-biphenyl (hereinafter referred to as TPD 232 film) 13 was formed by resistance heating deposition on the surface where the transparent electrode lines were formed so as to cover the transparent electrode 12. This TPD 232 film 13 functioned as a hole-injecting layer (a hole-transporting layer).

After the formation of the TPD 232 film 13, a 10 nm thick hole-transporting layer (hereinafter referred to as HTM) 14 was formed by resistance heating deposition. After the formation of the hole-transporting layer 14, a host compound (Host No. 1, Ip=5.6 eV, Eg=3.53 eV, Eg^{T}=2.85 eV) and a luminescent dopant (FIrpic, Eg=2.8 eV, Eg^{T}=2.7 eV) were co-deposited by resistance heating to form a 30 nm thick film 15 thereon. The concentration of FIrpic was 7.5 wt %. This Host No. 1:FIrpic film 15 functioned as an emitting layer.

After the formation of the emitting layer 15, a 30 nm thick electron-transporting layer 16 was formed by resistance heating deposition on the emitting layer using electron-transporting materials shown in Table 1 (ETM_No. 1 (Example 1), ETM_No. 2 (Example 2), ETM_No. 3 (Example 3) PC-7 (Example 4) and 8-hydroxyquinolinol aluminum complex (Alq) (Example 5)).

Thereafter, a 0.1 nm thick electron-transporting electrode (cathode) 17 was formed of LiF at a film-formation rate of 1 Å/minute. A metal Al was deposited on the LiF layer 17 to form a 130 nm thick metal cathode 18, thereby fabricating an organic EL device 100.

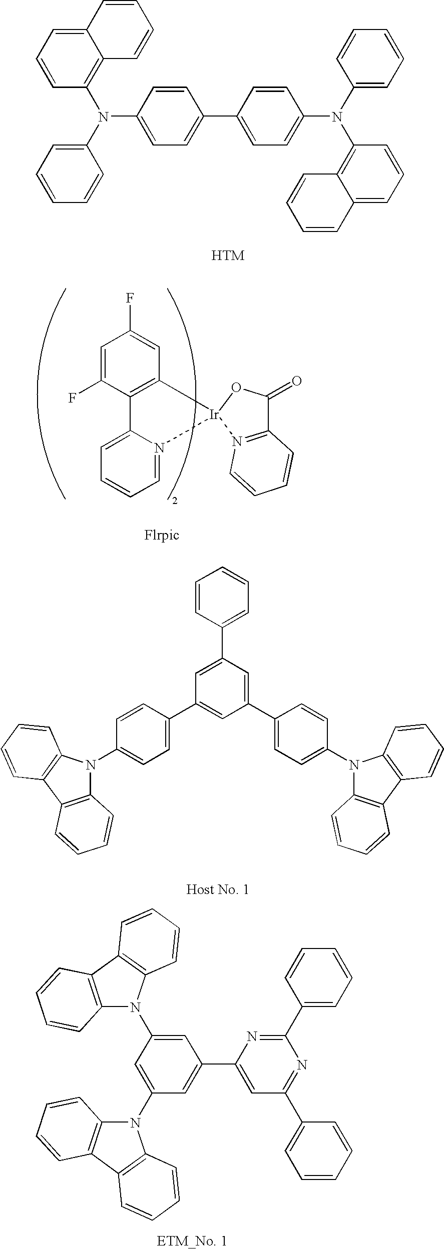

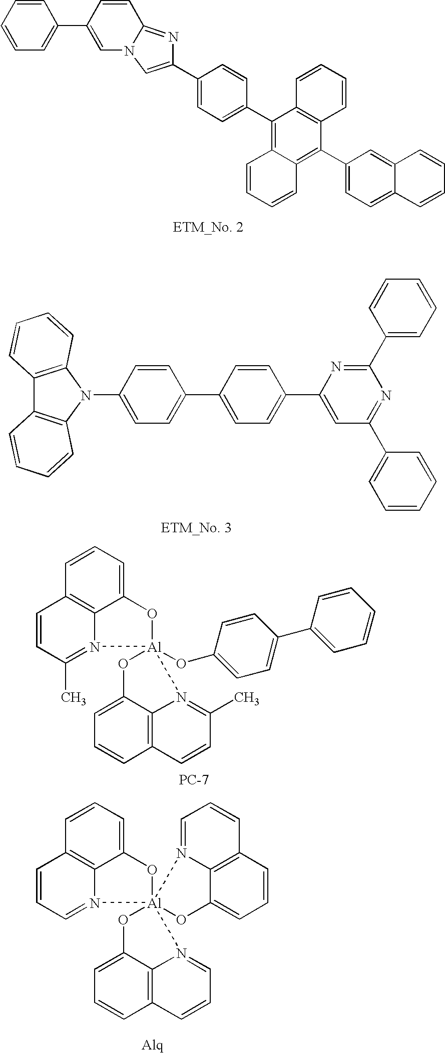

### Comparative Example 1

An organic EL device of the same structure was fabricated in the same manner as in Example 1 using the following compound as an electron-transporting material. 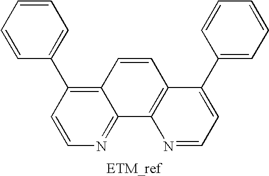
(Evaluation of Organic EL Device)

Luminance, efficiency and chromaticity of the organic EL devices obtained in the examples and the comparative example were measured in the condition of applying a certain DC voltage to calculate a current efficiency (=(luminance)/(current density)) at a luminance of about 100 cd/m². The results were shown in Table 1.

TABLE 1

| | Electron-transporting element | | | | | Current | | Current |
|---|---|---|---|---|---|---|---|---|
| | | IP | Eg | Eg^{T} | Voltage | density | | efficiency |
| | Type | (eV) | (eV) | (eV) | (V) | (mA/cm²) | CIE-(x, y) | (cd/A) |
| Example 1 | ETM_No. 1 | 5.7 | 3.5 | 2.90 | 6.0 | 0.83 | (0.20, 0.41) | 12.0 |
| Example 2 | ETM_No. 2 | 5.7 | 3.0 | 2.80 | 7.5 | 0.58 | (0.21, 0.41) | 17.0 |
| Example 3 | ETM_No. 3 | 5.8 | 3.3 | 2.60 | 6.0 | 0.83 | (0.21, 0.41) | 12.0 |
| Example 4 | PC-7 | 5.7 | 3.0 | less than 3.0 | 7.5 | 0.91 | (0.21, 0.41) | 11.0 |
| Example 5 | Alq | 5.7 | 2.7 | less than 2.7 | 8.0 | 1.01 | (0.21, 0.41) | 10.0 |
| Comparative | ETM_ref | 6.6 | 4.4 | 2.6 | 9.5 | 2.10 | (0.21, 0.41) | 4.9 |
| Example 1 | | | | | | | | |

Emitting layer: Host material (Host No. 1); Ip = 5.6 eV, Eg = 3.53 eV, Eg^{T} = 2.85 eV
Luminescent dopant (FIrpic); Eg = 2.8 eV, Eg^{T} = 2.7 eV

Table 1 shows that the L/J efficiency decreased in Comparative example compared with Examples since ΔIp was large (ΔIp=1 eV). A signal of hole's moving could not be measured by the Time of Flight method for the deposited film of the compound used in Comparative example. These results reveals that the invention realizes a device with a higher current efficiency than conventional devices which have the same emission color.

### Examples 6 and 7

A glass substrate, measuring 25 mm×75 mm×1.1 mm thick, with ITO transparent electrode lines (manufactured by Geomatics Co.) was subjected to ultrasonic cleaning in isopropyl alcohol for 5 minutes and then to UV ozone cleaning for 30 minutes. The cleaned glass substrate with transparent electrode lines was mounted on a substrate holder in a vacuum deposition device. First, a 100 nm thick TPD 232 film was formed by resistance heating deposition on the surface where the transparent electrode lines were formed so as to cover the transparent electrode. The TPD 232 film functioned as a hole-injecting (hole-transporting) layer.

After the formation of the TPD 232 film, a 10 nm thick hole-transporting layer (HTM) was formed by resistance heating deposition. After the formation of the hole-transporting layer, a host material (Host No. 1) and a luminescent dopant (FIrpic) were co-deposited by resistance heating to form a 30 nm thick film thereon. The concentration of FIrpic was 7.5 wt %. This Host No. 1:FIrpic film functioned as an emitting layer.

After the formation of the emitting layer, a 20 nm thick electron-transporting layer was formed by resistance heating deposition on the emitting layer using electron-transporting materials; ETM_No. 1 (Example 6) and ETM_No. 3 (Example 7).

A 10 nm thick Alq film was further formed to form an electron-transporting layer.

Thereafter, a 0.1 nm thick electron-transporting electrode (cathode) was formed of LiF at a film-formation rate of 1 Å/minute. A metal Al was deposited on the LiF layer to form a 130 nm thick metal cathode, thereby fabricating an organic EL device. The device was evaluated. The results are shown in Table 2.

### Example 8

An organic EL device of the same structure was fabricated in the same manner as in Example 6 except that ETM_No. 3 was used instead of Alq in Example 6. The results are shown in Table 2.

### Example 9

The same steps as in Example 7 were repeated until the formation of the ETM_No. 3 film and then a 10 nm thick Alq film was formed.

Thereafter, a 0.1 nm thick electron-transporting electrode (cathode) was formed of LiF at a film-formation rate of 1 Å/minute. A metal Al was deposited on the LiF layer to form a 130 nm thick metal cathode, thereby fabricating an organic EL device. The evaluation results are shown in Table 2.

TABLE 2

| | Electron-transporting material | | | | | Current | | Current |
|---|---|---|---|---|---|---|---|---|
| | | IP | Eg | Eg^{T} | Voltage | density | | efficiency |
| | Type*⁾ | (eV) | (eV) | (eV) | (V) | (mA/cm²) | CIE-(x, y) | (cd/A) |
| Example 6 | Alq | 5.7 | 2.7 | <2.7 | 6.2 | 0.29 | (0.18, 0.40) | 35 |
| | ETM_No. 1 | 5.7 | 3.5 | 2.90 | | | | |
| Example 7 | Alq | 5.7 | 2.7 | <2.7 | 6.5 | 0.29 | (0.18, 0.40) | 36 |
| | ETM_No. 3 | 5.8 | 3.3 | 2.60 | | | | |
| Example 8 | ETM_No. 3 | 5.8 | 3.3 | 2.60 | 6.0 | 0.29 | (0.18, 0.40) | 37 |
| | ETM_No. 1 | 5.7 | 3.5 | 2.90 | | | | |
| Example 9 | Alq | 5.7 | 2.7 | <2.7 | 6.0 | 0.29 | | |
| | ETM_No. 3 | 5.8 | 3.3 | 2.60 | | | (0.18, 0.40) | 37 |
| | ETM_No. 1 | 5.7 | 3.5 | 2.90 | | | | |

*⁾The upper material constitutes the electron-transporting layer on the metal electrode side. The lower material constitutes the electron-transporting layer contacting the emitting layer.
Emitting layer: Host material (Host No. 1); Ip = 5.6 eV, Eg = 3.53 eV, Eg^{T} = 2.85 eV
Luminescent dopant (FIrpic); Eg = 2.8 eV, Eg^{T} = 2.7 eV

The results revealed that the invention realizes a device with a higher current efficiency than conventional devices which have the same emission color.

### Examples 10 to 18

An organic EL device of the same structure was fabricated in the same manner as in Example 6 except that Etm_No. 4 to ETM_No. 12 shown below were used instead of ETM_No. 1 in Example 6. The evaluation results are shown in Table 3.

TABLE 3

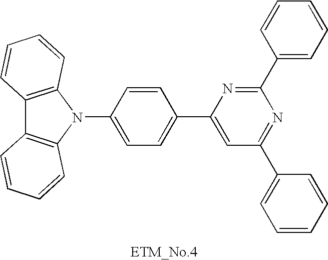

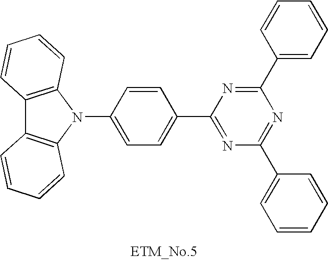

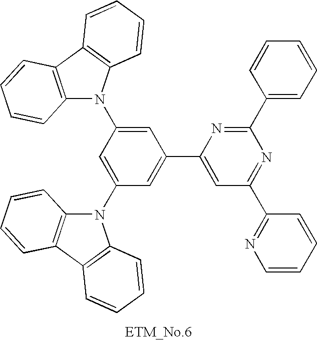

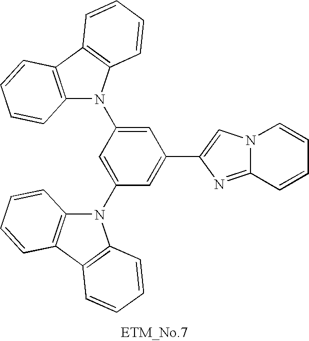

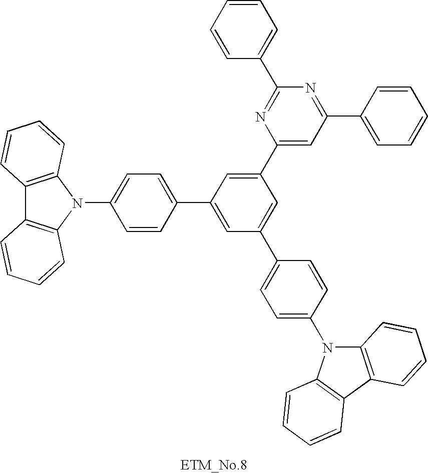

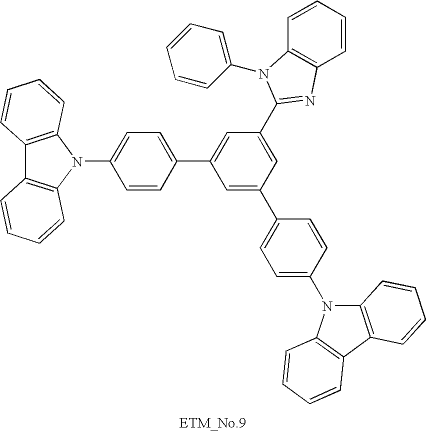

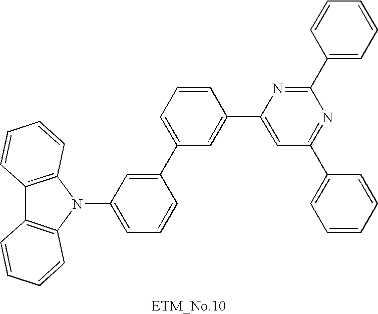

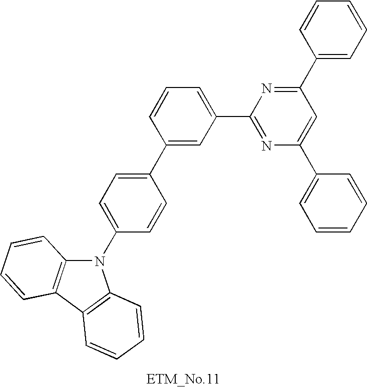

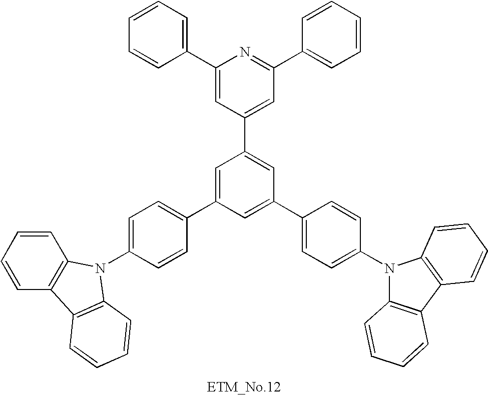

| | | Energy gap | | | Af | | Current | | | | Current |
|---|---|---|---|---|---|---|---|---|---|---|---|
| | | Eg | Eg^{T} | IP | (=Ip-Eg) | Voltage | density | Luminance | chromaticity | | efficiency |
| Example | Compound | (eV) | (eV) | (eV) | (eV) | (V) | (mA/cm²) | (nit) | x | y | (cd/A) |
| 10 | ETMNo.4 | 3.2 | 2.8 | 5.6 | 2.4 | 8.28 | 1.93 | 462 | 0.171 | 0.411 | 23.9 |
| 11 | ETMNo.5 | 3.1 | 2.8 | 5.6 | 2.5 | 7.47 | 2.01 | 447 | 0.168 | 0.389 | 22.3 |
| 12 | ETMNo.6 | 3.55 | 2.9 | 5.4 | 1.9 | 8.18 | 2.02 | 486 | 0.174 | 0.428 | 24.1 |
| 13 | ETMNo.7 | 3.44 | 2.8 | 5.5 | 2.1 | 7.89 | 0.69 | 115 | 0.174 | 0.404 | 16.7 |
| 14 | ETMNo.8 | 3.89 | 2.9 | 5.8 | 1.9 | 6.68 | 0.30 | 100 | 0.178 | 0.434 | 32.9 |
| 15 | ETMNo.9 | 3.5 | 2.8 | 5.5 | 2.0 | 7.96 | 0.88 | 101 | 0.173 | 0.404 | 11.5 |
| 16 | ETMNo.10 | 3.55 | 2.9 | 5.73 | 2.18 | 7.71 | 0.30 | 102 | 0.176 | 0.431 | 34.1 |
| 17 | ETMNo.11 | 3.53 | 2.88 | 5.8 | 2.2 | 7.35 | 0.58 | 101 | 0.173 | 0.419 | 17.4 |
| 18 | ETMNo.12 | 3.52 | 2.83 | 6.0 | 2.5 | 9.20 | 0.75 | 99 | 0.175 | 0.424 | 13.2 |

### INDUSTRIAL APPLICABILITY

The organic EL device of the invention can be used for an information display device, a display device for automobiles, a lighting and so on because its luminous efficiency is high at a high luminance and the electric power consumption is low. Specifically, it can be suitably used for a flat luminescent body for wall hanging TVs, a back lighting source for displays and so on.

The contents of the documents or publications cited in the description are incorporated herein.

1. An organic electroluminescent device having a multilayer structure comprising at least an emitting layer and an electron-transporting layer between a cathode and an anode, the triplet energy gap (Eg^{T}) of a host material forming the emitting layer being 2.52 eV or more and 3.7 eV or less, an electron-transporting material forming the electron-transporting layer being different from the host material, and having hole-transporting properties, and the emitting layer comprising a phosphorescent metal complex compound containing a heavy metal.

2. The organic electroluminescent device according to claim 1, wherein the ionization potential (Ip) of the electron-transporting material forming the electron-transporting layer is 5.6 eV or more and less than 6.0 eV.

3. The organic electroluminescent device according to claim 1, wherein the electron-transporting material forming the electron-transporting layer is at least an electron-deficient nitrogen-containing five-membered ring derivative or a nitrogen-containing six-membered ring derivative.

4. The organic electroluminescent device according to claim 1, wherein the electron-transporting material has one or more of the following structures (1) to (3). 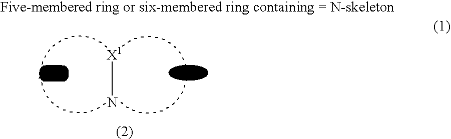
wherein X¹ is a carbon atom or a nitrogen atom, and Z¹ and Z² are independently atom groups which can form a nitrogen-containing hetero ring

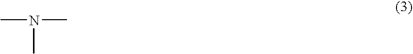

5. The organic electroluminescent device according to claim 1, wherein the electron-transporting material has a nitrogen-containing aromatic polycyclic group containing a five-membered ring or six-membered ring, and when the group contains a plurality of nitrogen atoms, the organic compound has a skeleton containing the nitrogen atoms in non-adjacent bonding positions.

6. The organic electroluminescent device according to claim 1, wherein the electron-transporting material or the host material is a compound having one carbazolyl group or tetrahydrocarbazolyl group.

7. The organic electroluminescent device according to claim 1, wherein the electron-transporting material or the host material is a compound having two carbazolyl groups or tetrahydrocarbazolyl groups.

8. The organic electroluminescent device according to claim 1, wherein the electron-transporting material or the host material is a compound having a carbazolyl group or a tetrahydrocarbazolyl group, and a nitrogen-containing hetero ring group.

9. The organic electroluminescent device according to claim 1, wherein a difference (ΔIp=Ip(electron-transporting material)−Ip(host material)) in ionization potential between the host material forming the emitting layer and the electron-transporting material forming the electron-transporting layer which contacts the emitting layer is −0.2 eV<ΔIp<0.4 eV.

10. The organic electroluminescent device according to claim 1, having a plurality of electron-transporting layers.

11. The organic electroluminescent device according to claim 10, wherein a difference (ΔIp′), represented by the following expression, in ionization potential between electron-transporting materials forming two adjacent layers of the plurality of electron-transporting layers is −0.2 eV<ΔIp′<0.4 eV,
ΔIp′=Ip(i)−Ip(i+1)
wherein Ip (i) is the ionization potential of an electron-transporting material forming an i-th electron-transporting layer from the emitting layer (i is an integer of 1 or more and (N-1) or less, and N is the number of the electron-transporting layers).

12. The organic electroluminescent device according to claim 10, wherein the optical energy gap (Eg) of an electron-transporting material forming an electron-transporting layer is equal to or smaller than the optical energy gap (Eg) of an electron-transporting material forming the adjacent electron-transporting layer nearer to the emitting layer.

13. The organic electroluminescent device according to claim 10, wherein the triplet energy gap of an electron-transporting material forming an electron-transporting layer is equal to or smaller than the triplet energy gap of an electron-transporting material forming the adjacent electron-transporting layer nearer to the emitting layer.

14. The organic electroluminescent device according to claim 1, wherein the triplet energy gap of the electron-transporting material forming the electron-transporting layer contacting the emitting layer is larger than the triplet energy gap of the metal complex compound of the emitting layer.
